(19) United States
(12) Patent Application Publication
(10) Pub. No.: US 2025/0031163 A1
(43) Pub. Date: Jan. 23, 2025

(54) METHOD AND APPARATUS FOR TRANSMITTING AND RECEIVING SYNCHRONIZATION SIGNAL BLOCK AND SYSTEM INFORMATION

(71) Applicant: Electronics and Telecommunications Research Institute, Daejeon (KR)

(72) Inventors: Jung Hoon LEE, Daejeon (KR); Cheul Soon KIM, Daejeon (KR); Sung Hyun Moon, Daejeon (KR)

(21) Appl. No.: 18/776,138

(22) Filed: Jul. 17, 2024

(30) Foreign Application Priority Data
Jul. 17, 2023 (KR) 10-2023-0092723
Jan. 16, 2024 (KR) 10-2024-0006908
Feb. 19, 2024 (KR) 10-2024-0023733
Apr. 4, 2024 (KR) 10-2024-0046038
May 10, 2024 (KR) 10-2024-0061989
Jul. 9, 2024 (KR) 10-2024-0090543

(51) Int. Cl. H04W 56/00; H04B 7/06; H04W 8/22

(52) U.S. Cl. CPC H04W 56/0015; H04B 7/0626; H04W 8/22

(57) ABSTRACT

A method of a terminal may comprise: receiving on-demand synchronization signal block (SSB) transmission configuration information from a first base station to which the terminal is connected; and receiving an on-demand SSB from a second base station based on the on-demand SSB transmission configuration information, wherein the on-demand SSB transmission configuration information includes at least one of capability information of the second base station, on-demand SSB resource information, a number of on-demand SSB transmissions, on-demand SSB transmission indication, or channel state information (CSI) configuration information.

### CROSS-REFERENCE TO RELATED APPLICATIONS

This application claims priority to Korean Patent Applications No. 10-2023-0092723, filed on Jul. 17, 2023, No. 10-2024-0006908, filed on Jan. 16, 2024, No. 10-2024-0023733, filed on Feb. 19, 2024, No. 10-2024-0046038, filed on Apr. 4, 2024, No. 10-2024-0061989, field on May 10, 2024, and No. 10-2024-0090543, filed on Jul. 9, 2024, with the Korean Intellectual Property Office (KIPO), the entire contents of which are hereby incorporated by reference.

### BACKGROUND

### 1. Technical Field

The present disclosure relates to a communication technique, and more particularly, to a technique for transmission and receiving on-demand synchronization signal block (SSB) and system information (SI).

### 2. Related Art

The communication system (e.g., a new radio (NR) communication system) using a higher frequency band (e.g., a frequency band of 6 GHz or above) than a frequency band (e.g., a frequency band of 6 GHz or below) of the long term evolution (LTE) communication system (or, LTE-A communication system) is being considered for processing of soaring wireless data. The NR system may support not only a frequency band of 6 GHz or below, but also a frequency band of 6 GHz or above, and may support various communication services and scenarios compared to the LTE system. In addition, requirements of the NR system may include enhanced Mobile BroadBand (eMBB), Ultra Reliable Low Latency Communication (URLLC), and Massive Machine Type Communication (mMTC).

Meanwhile, a base station may periodically transmit synchronization signal blocks (SSBs). A terminal may receive the SSB from the base station and perform an initial access procedure (e.g., synchronization procedure) based on the SSB. Due to the periodic transmission of SSBs, the energy consumption of the base station may increase. Therefore, methods for transmitting SSBs that reduce the energy consumption of the base station are required.

### SUMMARY

The present disclosure for resolving the above-described problems is directed to providing a method and an apparatus for transmitting and receiving synchronization signal block (SSB) and system information (SI).

A method of a terminal, according to exemplary embodiments of the present disclosure for achieving the above-described objective, may comprise: receiving on-demand synchronization signal block (SSB) transmission configuration information from a first base station to which the terminal is connected; and receiving an on-demand SSB from a second base station based on the on-demand SSB transmission configuration information, wherein the on-demand SSB transmission configuration information includes at least one of capability information of the second base station, on-demand SSB resource information, a number of on-demand SSB transmissions, on-demand SSB transmission indication, or channel state information (CSI) configuration information.

The capability information may include at least one of a cell identifier (ID), system bandwidth, numerology, number of beams, or antenna configuration of the second base station.

The on-demand SSB resource information may include time resource information for on-demand SSB transmission, frequency resource information for on-demand SSB transmission, periodicity information for on-demand SSB transmission, information on a time at which actual transmission of the on-demand SSB is started, or information a time at which the actual transmission of the on-demand SSB is terminated.

The time resource information may include at least one of a system frame number (SFN), a half radio frame indicator, a subframe index, a slot index, or information on actually transmitted SSB(s).

The frequency resource information may include at least one of information on a synchronization raster or information on an absolute radio frequency channel number (ARFCN).

The on-demand SSB transmission indication may be information indicating activation of the second base station.

The CSI configuration information may include information on a resource for reporting CSI generated based on a measurement result of the on-demand SSB.

The on-demand SSB may be a cell defining SSB or non-cell defining SSB.

The on-demand SSB may be received at a frequency position other than a synchronization raster.

When the on-demand SSB is a cell-defining SSB, the on-demand SSB may include a first barring indicator, and the first barring indicator may be used to block a legacy terminal from accessing the second base station.

When the terminal is a terminal capable of receiving the on-demand SSB, the terminal may ignore the first barring indicator included in the on-demand SSB, and the terminal may decide whether the terminal is barred from the second base station based on a second barring indicator included in remaining minimum system information (RMSI) received from the second base station.

A method of a first base station, according to exemplary embodiments of the present disclosure for achieving the above-described objective, may comprise: generating on-demand synchronization signal block (SSB) transmission configuration information including at least one of capability information of a second base station, on-demand SSB resource information, a number of on-demand SSB transmissions, on-demand SSB transmission indication, or channel state information (CSI) configuration information; and transmitting the on-demand SSB transmission configuration information a terminal, wherein an on-demand SSB based on the on-demand SSB transmission configuration information is transmitted from the second base station to the terminal.

The capability information may include at least one of a cell identifier (ID), system bandwidth, numerology, number of beams, or antenna configuration of the second base station.

The on-demand SSB resource information may include at least one of time resource information for on-demand SSB transmission, frequency resource information for on-demand SSB transmission, periodicity information for on-demand SSB transmission, information on a time at which actual transmission of the on-demand SSB is started, or information a time at which the actual transmission of the on-demand SSB is terminated.

When the on-demand SSB is a cell-defining SSB, the on-demand SSB may include a first barring indicator, and the first barring indicator may be used to block a legacy terminal from accessing the second base station.

The method may further comprise: when a synchronization procedure between the terminal and the second base station is not completed, generating modified on-demand SSB transmission configuration information; transmitting the modified on-demand SSB transmission configuration information to the second base station; and transmitting the modified on-demand SSB transmission configuration information to the terminal, wherein the on-demand SSB is retransmitted from the second base station to the terminal based on the modified on-demand SSB transmission configuration information.

A method of a second base station, according to exemplary embodiments of the present disclosure for achieving the above-described objective, may comprise: receiving on-demand synchronization signal block (SSB) transmission configuration information from a first base station; and transmitting an on-demand SSB to a terminal based on the on-demand SSB transmission configuration information, wherein the on-demand SSB transmission configuration information includes at least one of capability information of the second base station, on-demand SSB resource information, a number of on-demand SSB transmissions, on-demand SSB transmission indication, or channel state information (CSI) configuration information.

The capability information may include at least one of a cell identifier (ID), system bandwidth, numerology, number of beams, or antenna configuration of the second base station.

The on-demand SSB resource information may include at least one of time resource information for on-demand SSB transmission, frequency resource information for on-demand SSB transmission, periodicity information for on-demand SSB transmission, information on a time at which actual transmission of the on-demand SSB is started, or information a time at which the actual transmission of the on-demand SSB is terminated.

The method may further comprise: when a synchronization procedure between the terminal and the second base station is not completed, receiving modified on-demand SSB transmission configuration information from the first base station; and retransmitting the on-demand SSB to the terminal based on the modified on-demand SSB transmission configuration information.

According to the present disclosure, a macro base station can generate on-demand SSB transmission configuration information and transmit the on-demand SSB transmission configuration information to a small cell and/or a terminal. The small cell can transmit an on-demand SSB to the terminal based on the on-demand SSB transmission configuration information. The terminal can receive the on-demand SSB from the small cell based on the on-demand SSB transmission configuration information. According to the above operations, since the SSB (e.g., on-demand SSB) can be transmitted upon the request of the terminal, the signaling overhead of SSB transmission and the energy consumption due to SSB transmission can be reduced. Therefore, the performance of the communication system can be improved.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a type 1 frame.

FIG. 4 is a conceptual diagram illustrating exemplary embodiments of a type 2 frame.

FIG. 5 is a conceptual diagram illustrating exemplary embodiments of a first transmission method of SS/PBCH blocks in a communication system.

FIG. 6 is a conceptual diagram illustrating exemplary embodiments of an SS/PBCH block in a communication system.

FIG. 7 is a conceptual diagram illustrating exemplary embodiments of a second transmission method of SS/PBCH blocks in a communication system.

FIG. 8 is a conceptual diagram illustrating exemplary embodiments of SSB burst configuration.

FIG. 9A is a conceptual diagram illustrating an RMSI CORESET mapping pattern #1 in a communication system.

FIG. 9B is a conceptual diagram illustrating an RMSI CORESET mapping pattern #2 in a communication system.

FIG. 9C is a conceptual diagram illustrating an RMSI CORESET mapping pattern #3 in a communication system.

FIG. 10 is a conceptual diagram illustrating exemplary embodiments of configuration of a slot in which a PSFCH is configured.

FIG. 11 is a conceptual diagram illustrating exemplary embodiments of a PSFCH for ACK/NACK transmission.

FIG. 12 is a conceptual diagram illustrating exemplary embodiments of a method for multiplexing a control channel and a data channel in sidelink communication.

FIG. 13 is a conceptual diagram illustrating exemplary embodiments of a resource selection operation.

FIG. 14 is a conceptual diagram illustrating exemplary embodiments of a resource reselection operation.

FIG. 15 is a conceptual diagram illustrating deployment scenarios of a communication system.

FIGS. 16A and 16B are conceptual diagrams illustrating SSB transmission of a small cell in a preconfigured time period(s) (e.g., transmission periodicity).

FIGS. 17A, 17B, and 17C are conceptual diagrams illustrating SSB transmissions of a small cell in flexible time period(s) (e.g., flexible transmission periodicity).

FIG. 18 is a sequence chart illustrating exemplary embodiments of a method for transmitting on-demand SSB.

FIG. 19 is a conceptual diagram illustrating exemplary embodiments of S-SSB transmission and C-WUS transmission.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. The signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

In the present disclosure, a transmission time may mean a transmission start time or a transmission end time, and a reception time may mean a reception start time or a reception end time. A time point may refer to a time. In other words, ‘time point’ and ‘time’ may be used with the same meaning.

Hereinafter, even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

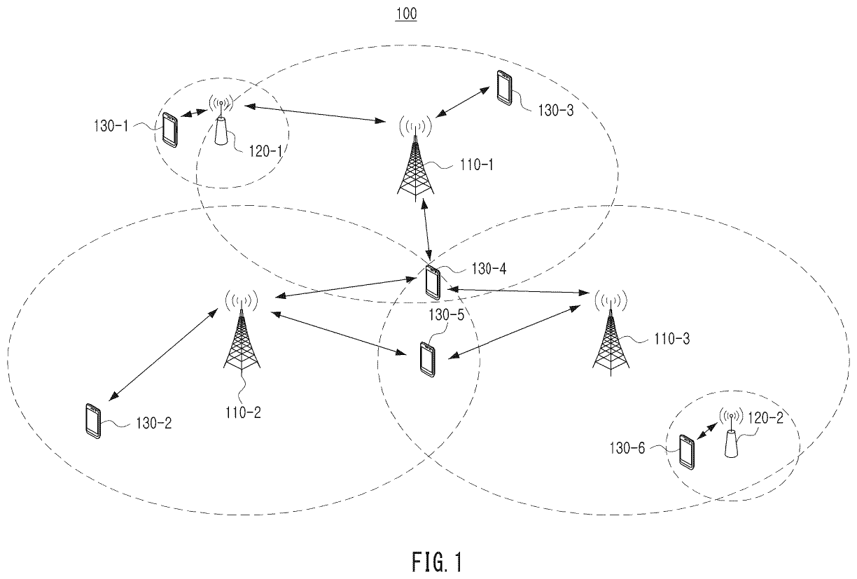

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

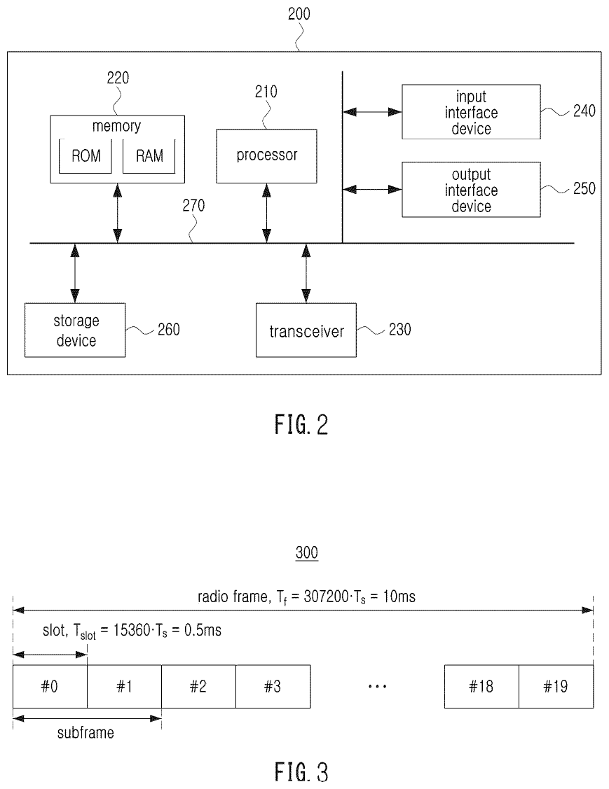

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (COMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system may support three types of frame structures. A type 1 frame structure may be applied to a frequency division duplex (FDD) communication system, a type 2 frame structure may be applied to a time division duplex (TDD) communication system, and a type 3 frame structure may be applied to an unlicensed band based communication system (e.g., a licensed assisted access (LAA) communication system).

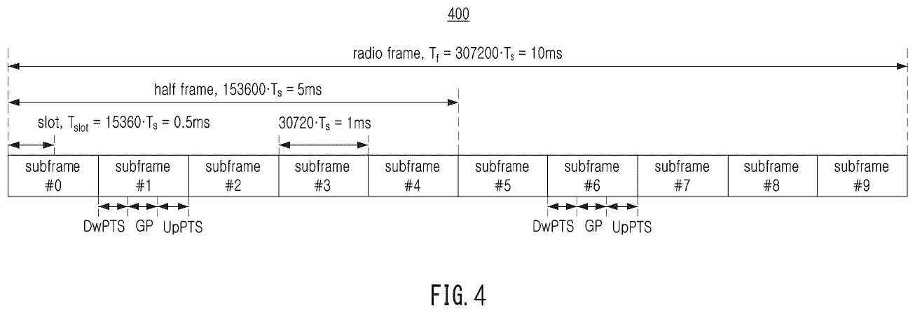

FIG. 3 is a conceptual diagram illustrating exemplary embodiments of a type 1 frame.

Referring to FIG. 3, a radio frame 300 may comprise 10 subframes, and a subframe may comprise 2 slots. Thus, the radio frame 300 may comprise 20 slots (e.g., slot #0, slot #1, slot #2, slot #3, . . . , slot #18, and slot #19). The length Tr of the radio frame 300 may be 10 milliseconds (ms). The length of the subframe may be 1 ms, and the length Tₛₗₒₜ of a slot may be 0.5 ms. Here, Tₛ may indicate a sampling time, and may be 1/30,720,000s.

The slot may be composed of a plurality of OFDM symbols in the time domain, and may be composed of a plurality of resource blocks (RBs) in the frequency domain. The RB may be composed of a plurality of subcarriers in the frequency domain. The number of OFDM symbols constituting the slot may vary depending on configuration of a cyclic prefix (CP). The CP may be classified into a normal CP and an extended CP. If the normal CP is used, the slot may be composed of 7 OFDM symbols, in which case the subframe may be composed of 14 OFDM symbols. If the extended CP is used, the slot may be composed of 6 OFDM symbols, in which case the subframe may be composed of 12 OFDM symbols.

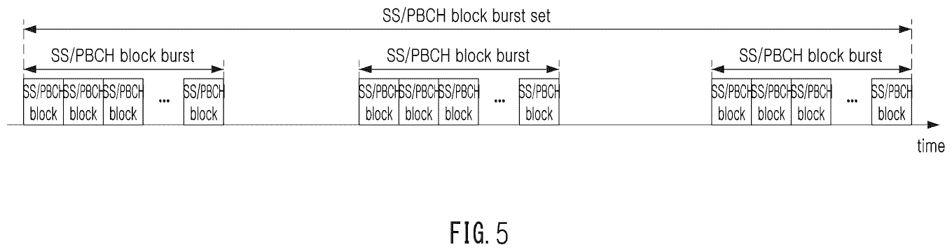

FIG. 4 is a conceptual diagram illustrating exemplary embodiments of a type 2 frame.

Referring to FIG. 4, a radio frame 400 may comprise two half frames, and a half frame may comprise 5 subframes. Thus, the radio frame 400 may comprise 10 subframes. The length T_{f} of the radio frame 400 may be 10 ms. The length of the half frame may be 5 ms. The length of the subframe may be 1 ms. Here, Tₛ may be 1/30,720,000s.

The radio frame 400 may include at least one downlink subframe, at least one uplink subframe, and a least one special subframe. Each of the downlink subframe and the uplink subframe may include two slots. The length Tₛₗₒₜ of a slot may be 0.5 ms. Among the subframes included in the radio frame 400, each of the subframe #1 and the subframe #6 may be a special subframe. For example, when a switching periodicity between downlink and uplink is 5 ms, the radio frame 400 may include 2 special subframes. Alternatively, the switching periodicity between downlink and uplink is 10 ms, the radio frame 400 may include one special subframe. The special subframe may include a downlink pilot time slot (DwPTS), a guard period (GP), and an uplink pilot time slot (UpPTS).

The downlink pilot time slot may be regarded as a downlink interval and may be used for cell search, time and frequency synchronization acquisition of the terminal, channel estimation, and the like. The guard period may be used for resolving interference problems of uplink data transmission caused by delay of downlink data reception. Also, the guard period may include a time required for switching from the downlink data reception operation to the uplink data transmission operation. The uplink pilot time slot may be used for uplink channel estimation, time and frequency synchronization acquisition, and the like. Transmission of a physical random access channel (PRACH) or a sounding reference signal (SRS) may be performed in the uplink pilot time slot.

The lengths of the downlink pilot time slot, the guard period, and the uplink pilot time slot included in the special subframe may be variably adjusted as needed. In addition, the number and position of each of the downlink subframe, the uplink subframe, and the special subframe included in the radio frame 400 may be changed as needed.

In the communication system, a transmission time interval (TTI) may be a basic time unit for transmitting coded data through a physical layer. A short TTI may be used to support low latency requirements in the communication system. The length of the short TTI may be less than 1 ms. The conventional TTI having a length of 1 ms may be referred to as a base TTI or a regular TTI. That is, the base TTI may be composed of one subframe. In order to support transmission on a base TTI basis, signals and channels may be configured on a subframe basis. For example, a cell-specific reference signal (CRS), a physical downlink control channel (PDCCH), a physical downlink shared channel (PDSCH), a physical uplink control channel (PUCCH), a physical uplink shared channel (PUSCH), and the like may exist in each subframe.

On the other hand, a synchronization signal (e.g., a primary synchronization signal (PSS) and a secondary synchronization signal (SSS)) may exist for every 5 subframes, and a physical broadcast channel (PBCH) may exist for every 10 subframes. Also, each radio frame may be identified by an SFN, and the SFN may be used for defining transmission of a signal (e.g., a paging signal, a reference signal for channel estimation, a signal for channel state information, etc.) longer than one radio frame. The periodicity of the SFN may be 1024.

In the LTE system, the PBCH may be a physical layer channel used for transmission of system information (e.g., master information block (MIB)). The PBCH may be transmitted every 10 subframes. That is, the transmission periodicity of the PBCH may be 10 ms, and the PBCH may be transmitted once in the radio frame. The same MIB may be transmitted during 4 consecutive radio frames, and after 4 consecutive radio frames, the MIB may be changed according to a situation of the LTE system. The transmission period for which the same MIB is transmitted may be referred to as a ‘PBCH TTI’, and the PBCH TTI may be 40 ms. That is, the MIB may be changed for each PBCH TTI.

The MIB may be composed of 40 bits. Among the 40 bits constituting the MIB, 3 bits may be used to indicate a system band, 3 bits may be used to indicate physical hybrid automatic repeat request (ARQ) indicator channel (PHICH) related information, 8 bits may be used to indicate an SFN, 10 bits may be configured as reserved bits, and 16 bits may be used for a cyclic redundancy check (CRC).

The SFN for identifying the radio frame may be composed of a total of 10 bits (B9 to B0), and the most significant bits (MSBs) 8 bits (B9 to B2) among the 10 bits may be indicated by the PBCH (i.e., MIB). The MSBs 8 bits (B9 to B2) of the SFN indicated by the PBCH (i.e., MIB) may be identical during 4 consecutive radio frames (i.e., PBCH TTI). The least significant bits (LSBs) 2 bits (B1 to B0) of the SFN may be changed during 4 consecutive radio frames (i.e., PBCH TTI), and may not be explicitly indicated by the PBCH (i.e., MIB). The LSBs (2 bits (B1 to B0)) of the SFN may be implicitly indicated by a scrambling sequence of the PBCH (hereinafter referred to as ‘PBCH scrambling sequence’).

A gold sequence generated by being initialized by a cell ID may be used as the PBCH scrambling sequence, and the PBCH scrambling sequence may be initialized for each four consecutive radio frames (e.g., each PBCH TTI) based on an operation of ‘mod (SFN, 4)’. The PBCH transmitted in a radio frame corresponding to an SFN with LSBs 2 bits (B1 to B0) set to ‘00’ may be scrambled by the gold sequence generated by being initialized by the cell ID. Thereafter, the gold sequences generated according to the operation of ‘mod (SFN, 4)’ may be used to scramble the PBCH transmitted in the radio frames corresponding to SFNs with LSBs 2 bits (B1 to B0) set to ‘01’, ‘10’, and ‘11’.

Accordingly, the terminal having acquired the cell ID in the initial cell search process may identify the value of the LSBs 2 bits (B1 to B0) of the SFN (e.g., ‘00’, ‘01’, ‘10’, or ‘11’) based on the PBCH scramble sequence obtained in the decoding process for the PBCH (i.e., MIB). The terminal may use the LSBs 2 bits (B1 to B0) of the SFN obtained based on the PBCH scrambling sequence and the MSBs 8 bits (B9 to B2) of the SFN indicated by the PBCH (i.e., MIB) so as to identify the SFN (i.e., the entire bits B9 to B0 of the SFN).

On the other hand, the communication system may support not only a high transmission rate but also technical requirements for various service scenarios. For example, the communication system may support an enhanced mobile broadband (eMBB) service, an ultra-reliable low-latency communication (URLLC) service, a massive machine type communication (mMTC) service, and the like.

The subcarrier spacing of the communication system (e.g., OFDM-based communication system) may be determined based on a carrier frequency offset (CFO) and the like. The CFO may be generated by a Doppler effect, a phase drift, or the like, and may increase in proportion to an operation frequency. Therefore, in order to prevent the performance degradation of the communication system due to the CFO, the subcarrier spacing may increase in proportion to the operation frequency. On the other hand, as the subcarrier spacing increases, a CP overhead may increase. Therefore, the subcarrier spacing may be configured based on a channel characteristic, a radio frequency (RF) characteristic, etc. according to a frequency band.

The communication system may support numerologies defined in Table 1 below.

TABLE 1

| Numerology (μ) | 0 | 1 | 2 | 3 | 4 | 5 |
|---|---|---|---|---|---|---|
| Subcarrier spacing | 15 kHz | 30 kHz | 60 kHz | 120 kHz | 240 kHz | 480 kHz |
| OFDM symbol length [us] | 66.7 | 33.3 | 16.7 | 8.3 | 4.2 | 2.1 |
| CP length [us] | 4.76 | 2.38 | 1.19 | 0.60 | 0.30 | 0.15 |
| Number of OFDM symbols | 14 | 28 | 56 | 112 | 224 | 448 |
| within 1 ms | | | | | | |

For example, the subcarrier spacing of the communication system may be configured to 15 kHz, 30 kHz, 60 kHz, or 120 kHz. The subcarrier spacing of the LTE system may be 15 kHz, and the subcarrier spacing of the NR system may be 1, 2, 4, or 8 times the conventional subcarrier spacing of 15 kHz. If the subcarrier spacing increases by exponentiation units of 2 of the conventional subcarrier spacing, the frame structure can be easily designed.

The communication system may support FR1 as well as FR2. The FR2 may be classified into FR2-1 and FR2-2. The FR1 may be a frequency band of 6 GHz or below, the FR2-1 may be a frequency band of 24.25 to 52.6, and the FR2-2 may be a frequency band of 52.6 to 71 GHz. In an exemplary embodiment, the FR2 may be the FR2-1, the FR2-1, or a frequency band including the FR2-1 and FR2-2. In each of the FR1, FR2-1, and FR2-2, subcarrier spacings available for data transmission may be defined as shown in Table 2 below. In each of the FR1, the FR2-1, and the FR2-2, SCSs available for synchronization signal block (SSB) transmission may be defined as shown in Table 3 below. In each of the FR1, the FR2-1, and the FR2-2, SCSs available for RACH transmission (e.g., Msg1 or Msg-A) may be defined as shown in Table 4 below.

TABLE 2
data

| FR1 | FR2-1 | FR2-2 |
|---|---|---|
| 15 kHz, 30 kHz, | 60 kHz, 120 kHz | 120 kHz, 480 kHz, |
| 60 kHz (optional) | | 960 kHz |

TABLE 3
SSB

| FR1 | FR2-1 | FR2-2 |
|---|---|---|
| 15 kHz, 30 kHz | 120 kHz, 240 kHz | 120 kHz, 480 kHz, |
| | | 960 kHz |

TABLE 4
RACH

| FR1 | FR2-1 | FR2-2 |
|---|---|---|
| 1.25 kHz, 5 kHz, | 60 kHz, 120 kHz | 120 kHz, 480 kHz, |
| 15 kHz, 30 kHz | | 960 kHz |

The communication system may support a wide frequency band (e.g., several hundred MHz to tens of GHz). Since the diffraction characteristic and the reflection characteristic of the radio wave are poor in a high frequency band, a propagation loss (e.g., path loss, reflection loss, and the like) in a high frequency band may be larger than a propagation loss in a low frequency band. Therefore, a cell coverage of a communication system supporting a high frequency band may be smaller than a cell coverage of a communication system supporting a low frequency band. In order to solve such the problem, a beamforming scheme based on a plurality of antenna elements may be used to increase the cell coverage in the communication system supporting a high frequency band.

The beamforming scheme may include a digital beamforming scheme, an analog beamforming scheme, a hybrid beamforming scheme, and the like. In the communication system using the digital beamforming scheme, a beamforming gain may be obtained using a plurality of RF paths based on a digital precoder or a codebook. In the communication system using the analog beamforming scheme, a beamforming gain may be obtained using analog RF devices (e.g., phase shifter, power amplifier (PA), variable gain amplifier (VGA), and the like) and an antenna array.

Because of the need for expensive digital to analog converters (DACs) or analog to digital converters (ADCs) for digital beamforming schemes and transceiver units corresponding to the number of antenna elements, the complexity of antenna implementation may be increased to increase the beamforming gain. In case of the communication system using the analog beamforming scheme, since a plurality of antenna elements are connected to one transceiver unit through phase shifters, the complexity of the antenna implementation may not increase greatly even if the beamforming gain is increased. However, the beamforming performance of the communication system using the analog beamforming scheme may be lower than the beamforming performance of the communication system using the digital beamforming scheme. Further, in the communication system using the analog beamforming scheme, since the phase shifter is adjusted in the time domain, frequency resources may not be efficiently used. Therefore, a hybrid beamforming scheme, which is a combination of the digital scheme and the analog scheme, may be used.

When the cell coverage is increased by the use of the beamforming scheme, common control channels and common signals (e.g., reference signal and synchronization signal) for all terminals belonging to the cell coverage as well as control channels and data channels for each terminal may also be transmitted based on the beamforming scheme. In this case, the common control channels and the common signals for all terminals belonging to the cell coverage may be transmitted based on a beam sweeping scheme.

In addition, in the NR system, a synchronization signal/physical broadcast channel (SS/PBCH) block may also be transmitted in a beam sweeping scheme. The SS/PBCH block may be composed of a PSS, an SSS, a PBCH, and the like. In the SS/PBCH block, the PSS, the SSS, and the PBCH may be configured in a time division multiplexing (TDM) manner. The SS/PBCH block may be referred also to as an ‘SS block (SSB)’. One SS/PBCH block may be transmitted using N consecutive OFDM symbols. Here, N may be an integer equal to or greater than 4. The base station may periodically transmit the SS/PBCH block, and the terminal may acquire frequency/time synchronization, a cell ID, system information, and the like based on the SS/PBCH block received from the base station. The SS/PBCH block may be transmitted as follows.

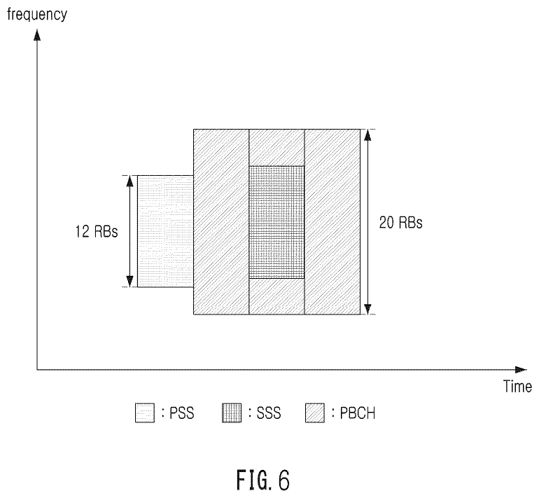

FIG. 5 is a conceptual diagram illustrating exemplary embodiments of a first transmission method of SS/PBCH blocks in a communication system.

Referring to FIG. 5, one or more SS/PBCH blocks may be transmitted in a beam sweeping scheme within an SS/PBCH block burst set. Up to L SS/PBCH blocks may be transmitted within one SS/PBCH block burst set. L may be an integer equal to or greater than 2, and may be defined in the 3GPP standard. Depending on a region of a system frequency, L may vary. Within the SS/PBCH block burst set, the SS/PBCH blocks may be located consecutively or distributedly. The consecutive SS/PBCH blocks may be referred to as an ‘SS/PBCH block burst’. The SS/PBCH block burst set may be repeated periodically, and system information (e.g., MIB) transmitted through the PBCHs of the SS/PBCH blocks within the SS/PBCH block burst set may be the same. An index of the SS/PBCH block, an index of the SS/PBCH block burst, an index of an OFDM symbol, an index of a slot, and the like may be indicated explicitly or implicitly by the PBCH.

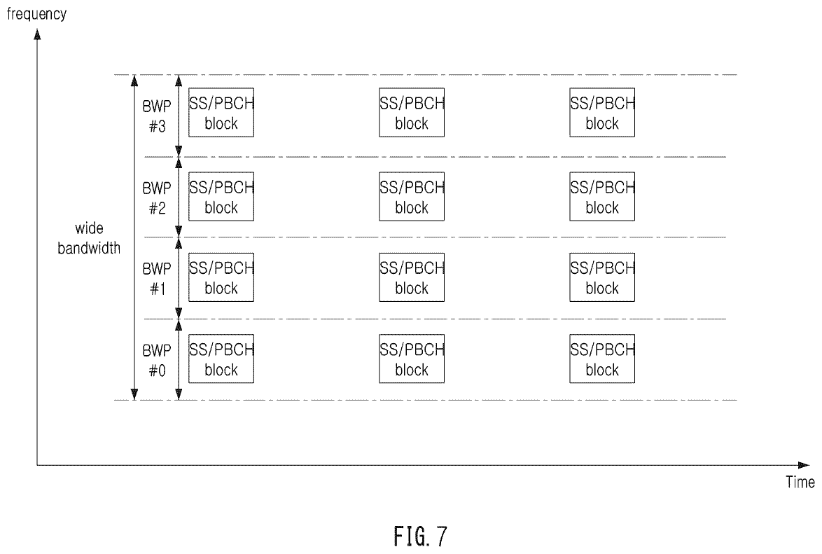

FIG. 6 is a conceptual diagram illustrating exemplary embodiments of an SS/PBCH block in a communication system.

Referring to FIG. 6, signals and a channel are arranged within one SS/PBCH block in the order of ‘PSS→PBCH→SSS→PBCH’. The PSS, SSS, and PBCH within the SS/PBCH block may be configured in a TDM scheme. In a symbol where the SSS is located, the PBCH may be located in frequency resources above the SSS and frequency resources below the SSS. That is, the PBCH may be transmitted in both end bands adjacent to the frequency band in which the SSS is transmitted. When the maximum number of SS/PBCH blocks is 8 in the sub 6 GHz frequency band, an SS/PBCH block index may be identified based on a demodulation reference signal used for demodulating the PBCH (hereinafter, referred to as ‘PBCH DMRS’). When the maximum number of SSBs is 64 in the over 6 GHz frequency band, LSB 3 bits of 6 bits representing the SS/PBCH block index may be identified based on the PBCH DMRS, and the remaining MSB 3 bits may be identified based on a payload of the PBCH.

The maximum system bandwidth that can be supported in the NR system may be 400 MHz. The size of the maximum bandwidth that can be supported by the terminal may vary depending on the capability of the terminal. Therefore, the terminal may perform an initial access procedure (e.g., initial connection procedure) by using some of the system bandwidth of the NR system supporting a wide band. In order to support access procedures of terminals supporting various sizes of bandwidths, SS/PBCH blocks may be multiplexed in the frequency domain within the system bandwidth of the NR system supporting a wide band. In this case, the SS/PBCH blocks may be transmitted as follows.

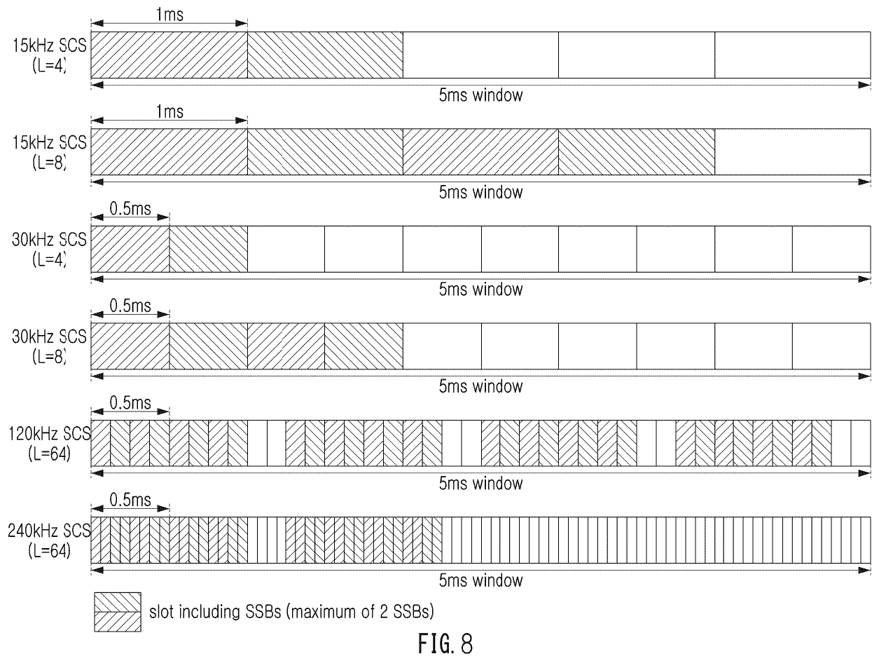

FIG. 7 is a conceptual diagram illustrating exemplary embodiments of a second transmission method of SS/PBCH blocks in a communication system.

Referring to FIG. 7, a wideband component carrier (CC) may include a plurality of bandwidth parts (BWPs). For example, the wideband CC may include 4 BWPs. The base station may transmit SS/PBCH blocks in the respective BWPs #0 to #3 belonging to the wideband CC. The terminal may receive the SS/PBCH block(s) from one or more BWPs of the BWPs #0 to #3, and may perform an initial access procedure using the received SS/PBCH block.

After detecting the SS/PBCH block, the terminal may acquire system information (e.g., remaining minimum system information (RMSI)), and may perform a cell access procedure based on the system information. The RMSI may be transmitted on a PDSCH scheduled by a PDCCH. Configuration information of a control resource set (CORESET) in which the PDCCH including scheduling information of the PDSCH through which the RMSI is transmitted may be transmitted on a PBCH within the SS/PBCH block. A plurality of SS/PBCH blocks may be transmitted in the entire system band, and one or more SS/PBCH blocks among the plurality of SS/PBCH blocks may be SS/PBCH block(s) associated with the RMSI. The remaining SS/PBCH blocks may not be associated with the RMSI. The SS/PBCH block associated with the RMSI may be defined as a ‘cell defining SS/PBCH block’. The terminal may perform a cell search procedure and an initial access procedure by using the cell-defining SS/PBCH block. The SS/PBCH block not associated with the RMSI may be used for a synchronization procedure and/or a measurement procedure in the corresponding BWP. The BWP(s) through which the SS/PBCH block is transmitted may be limited to one or more BWPs within a wide bandwidth.

The positions at which the SSBs are transmitted in the time domain may be defined differently according to an SCS and a value of L. In exemplary embodiments, the SCS may mean a subcarrier size. The SSB may be transmitted in some symbols within one slot, and a short UL transmission (e.g., uplink control information (UCI) transmission) may be performed in the remaining symbols not used for the SSB transmission within one slot. When the SSB is transmitted in radio resources to which a large SCS (e.g., 120 kHz SCS or 240 KHz SCS) is applied, a gap may be configured in the middle of consecutive slots including the SSB so that a long UL transmission (e.g., transmission of URLLC traffic) can be performed at least every 1 ms.

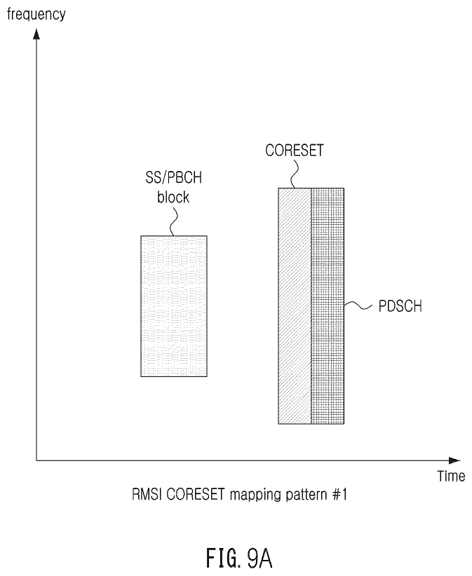

FIG. 8 is a conceptual diagram illustrating exemplary embodiments of SSB burst configuration.

Referring to FIG. 8, in a transmission procedure of SSBs (e.g., SSB burst) in radio resources to which a 120 kHz SCS is applied, the base station may transmit SSBs in 8 consecutive slots. In a transmission procedure of SSBs in radio resources to which s 240 kHz SCS is applied, the base station may transmit SSBs in 16 consecutive slots. In the radio resources to which the 120 kHz SCS or 240 kHz SCS is applied, a gap for UL transmission may be configured.

The RMSI may be obtained by performing an operation to obtain configuration information of a CORESET from the SS/PBCH block (e.g., PBCH), an operation of detecting a PDCCH based on the configuration information of the CORESET, an operation to obtain scheduling information of a PDSCH from the PDCCH, and an operation to receive the RMSI on the PDSCH. A transmission resource of the PDCCH may be configured by the configuration information of the CORESET. A mapping patter of the RMSI CORESET pattern may be defined as follows. The RMSI CORESET may be a CORESET used for transmission and reception of the RMSI.

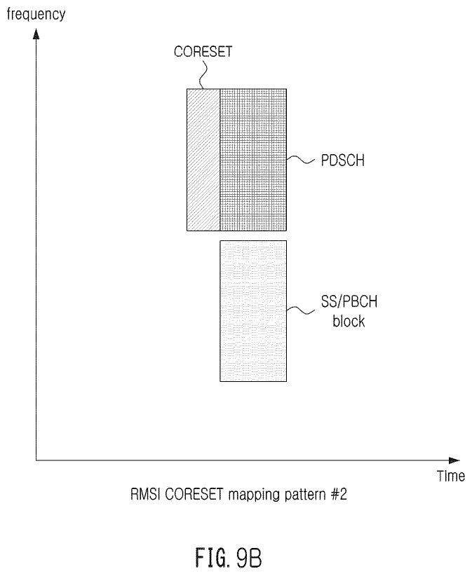

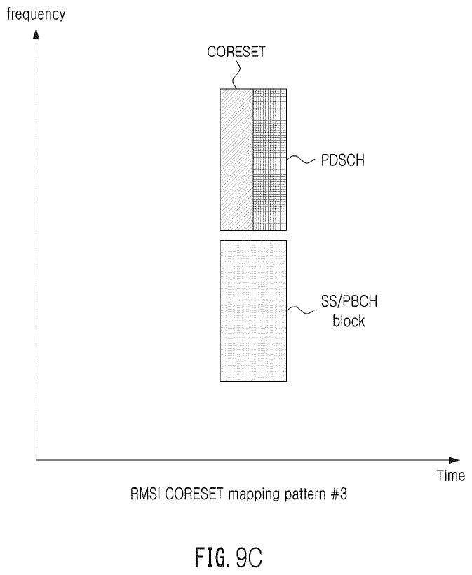

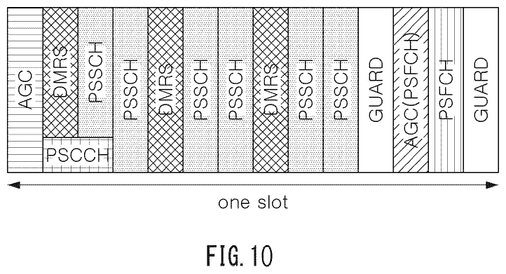

FIG. 9A is a conceptual diagram illustrating an RMSI CORESET mapping pattern #1 in a communication system, FIG. 9B is a conceptual diagram illustrating an RMSI CORESET mapping pattern #2 in a communication system, and FIG. 9C is a conceptual diagram illustrating an RMSI CORESET mapping pattern #3 in a communication system.

Referring to FIGS. 9A to 9C, one RMSI CORESET mapping pattern among the RMSI CORESET mapping patterns #1 to #3 may be used, and a detailed configuration according to the one RMSI CORESET mapping pattern may be determined. In the RMSI CORESET mapping pattern #1, the SS/PBCH block, the CORESET (i.e., RMSI CORESET), and the PDSCH (i.e., RMSI PDSCH) may be configured in a TDM scheme. The RMSI PDSCH may mean the PDSCH through which the RMSI is transmitted. In the RMSI CORESET mapping pattern #2, the CORESET (i.e., RMSI CORESET) and the PDSCH (i.e., RMSI PDSCH) may be configured in a TDM scheme, and the PDSCH (i.e., RMSI PDSCH) and the SS/PBCH block may be configured in a frequency division multiplexing (FDM) scheme. In the RMSI CORESET mapping pattern #3, the CORESET (i.e., RMSI CORESET) and the PDSCH (i.e., RMSI PDSCH) may be configured in a TDM scheme, and the CORESET (i.e., RMSI CORESET) and the PDSCH (i.e., RMSI PDSCH) may be multiplexed with the SS/PBCH block in a FDM scheme.

In the frequency band of 6 GHz or below, only the RMSI CORESET mapping pattern #1 may be used. In the frequency band of 6 GHz or above, all of the RMSI CORESET mapping patterns #1, #2, and #3 may be used. The numerology of the SS/PBCH block may be different from that of the RMSI CORESET and the RMSI PDSCH. Here, the numerology may be a subcarrier spacing. In the RMSI CORESET mapping pattern #1, a combination of all numerologies may be used. In the RMSI CORESET mapping pattern #2, a combination of numerologies (120 kHz, 60 kHz) or (240 kHz, 120 kHz) may be used for the SS/PBCH block and the RMSI CORESET/PDSCH. In the RMSI CORESET mapping pattern #3, a combination of numerologies (120 kHz, 120 kHz) may be used for the SS/PBCH block and the RMSI CORESET/PDSCH.

One RMSI CORESET mapping pattern may be selected from the RMSI CORESET mapping patterns #1 to #3 according to the combination of the numerology of the SS/PBCH block and the numerology of the RMSI CORESET/PDSCH. The configuration information of the RMSI CORESET may include Table A and Table B. Table A may represent the number of resource blocks (RBs) of the RMSI CORESET, the number of symbols of the RMSI CORESET, and an offset between an RB (e.g., starting RB or ending RB) of the SS/PBCH block and an RB (e.g., starting RB or ending RB) of the RMSI CORESET. Table B may represent the number of search space sets per slot, an offset of the RMSI CORESET, and an OFDM symbol index in each of the RMSI CORESET mapping patterns. Table B may represent information for configuring a monitoring occasion of the RMSI PDCCH. Each of Table A and Table B may be composed of a plurality of sub-tables. For example, Table A may include sub-tables 13-1 to 13-8 defined in the technical specification (TS) 38.213, and Table B may include sub-tables 13-9 to 13-13 defined in the TS 38.213. The size of each of Table A and Table B may be 4 bits.

In the NR system, a PDSCH may be mapped to the time domain according to a PDSCH mapping type A or a PDSCH mapping type B. The PDSCH mapping types A and B may be defined as Table 5 below.

TABLE 5

| PDSCH | | | | | | |
|---|---|---|---|---|---|---|
| mapping | Normal CP | | | Extended CP | | |
| type | S | L | S + L | S | L | S + L |
| Type A | {0, 1, 2, 3} | {3, . . . , 14} | {3, . . . , 14} | {0, 1, 2, 3} | {3, . . . , 12} | {3, . . . , 12} |
| | (Note 1) | | | (Note 1) | | |
| Type B | {0, . . . , 12} | {2, 4, 7} | {2, . . . , 14} | {0, . . . , 10} | {2, 4, 6} | {2, . . . , 12} |

(Note 1):
S = 3 is applicable only if dmrs-TypeA-Position = 3

The type A (i.e., PDSCH mapping type A) may be slot-based transmission. When the type A is used, a position of a start symbol of a PDSCH may be configured to one of {0, 1, 2, 3}. When the type A and a normal CP are used, the number of symbols constituting the PDSCH (e.g., the duration of the PDSCH) may be configured to one of 3 to 14 within a range not exceeding a slot boundary. The type B (i.e., PDSCH mapping type B) may be non-slot-based transmission. When the type B is used, a position of a start symbol of a PDSCH may be configured to one of 0 to 12. When the type B and the normal CP are used, the number of symbols constituting the PDSCH (e.g., the duration of the PDSCH) may be configured to one of {2, 4, 7} within a range not exceeding a slot boundary. A DMRS (hereinafter, referred to as ‘PDSCH DMRS’) for demodulation of the PDSCH (e.g., data) may be determined by the PDSCH mapping type (e.g., type A or type B) and an ID indicating the length. The ID may be defined differently according to the PDSCH mapping type.

Meanwhile, NR-unlicensed (NR-U) is being discussed in the NR standardization meeting. The NR-U system may increase network capacity by improving the utilization of limited frequency resources. The NR-U system may support operation in an unlicensed band (e.g., unlicensed spectrum).

In the NR-U system, the terminal may determine whether a signal is transmitted from a base station based on a discovery reference signal (DRS) received from the corresponding base station in the same manner as in the general NR system. In the NR-U system in a Stand-Alone (SA) mode, the terminal may acquire synchronization and/or system information based on the DRS. In the NR-U system, the DRS may be transmitted according to a regulation of the unlicensed band (e.g., transmission band, transmit power, transmission time, etc.). For example, according to Occupied Channel Bandwidth (OCB) regulations, signals may be configured and/or transmitted to occupy 80% of the total channel bandwidth (e.g., 20 MHz).

In the NR-U system, a communication node (e.g., base station, terminal) may perform a Listen Before Talk (LBT) procedure before transmitting a signal and/or a channel for coexistence with another system. The signal may be a synchronization signal, a reference signal (e.g., DRS, DMRS, channel state information (CSI)-RS, phase tracking (PT)-RS, sounding reference signal (SRS)), or the like. The channel may be a downlink channel, an uplink channel, a sidelink channel, or the like. In exemplary embodiments, a signal may mean the ‘signal’, the ‘channel’, or the ‘signal and channel’. The LBT procedure may be an operation for checking whether a signal is transmitted by another communication node. If it is determined by the LBT procedure that there is no transmission signal (e.g., when the LBT procedure is successful), the communication node may transmit a signal in the unlicensed band. If it is determined by the LBT procedure that a transmission signal exists (e.g., when the LBT fails), the communication node may not be able to transmit a signal in the unlicensed band. The communication node may perform a LBT procedure according to one of various categories before transmission of a signal. The category of LBT may vary depending on the type of the transmission signal.

Meanwhile, NR vehicle-to-everything (V2X) communication technology is being discussed in the NR standardization meeting. The NR V2X communication technology may be a technology that supports communication between vehicles, communication between a vehicle and an infrastructure, communication between a vehicle and a pedestrian, and the like based on device-to-device (D2D) communication technologies. Techniques for reducing power consumption and improving reliability are being discussed for NR V2C communication.

The NR V2X communication (e.g., sidelink communication) may be performed according to three transmission schemes (e.g., unicast scheme, broadcast scheme, groupcast scheme). When the unicast scheme is used, a PC5-RRC connection may be established between a first terminal (e.g., transmitting terminal that transmits data) and a second terminal (e.g., receiving terminal that receives data), and the PC5-RRC connection may refer to a logical connection for a pair between a source ID of the first terminal and a destination ID of the second terminal. The first terminal may transmit data (e.g., sidelink data) to the second terminal. When the broadcast scheme is used, the first terminal may transmit data to all terminals. When the groupcast scheme is used, the first terminal may transmit data to a group (e.g., groupcast group) composed of a plurality of terminals. In SL communication (e.g., SL-U communication), a transmitting terminal may mean a terminal transmitting data, and a receiving terminal may mean a terminal receiving the data. The SL-U communication may refer to SL communication in an unlicensed band.

When the unicast scheme is used, the second terminal may transmit feedback information (e.g., acknowledgment (ACK) or negative ACK (NACK)) to the first terminal in response to data received from the first terminal. In the exemplary embodiments below, the feedback information may be referred to as a ‘HARQ-ACK’, ‘feedback signal’, a ‘physical sidelink feedback channel (PSFCH) signal’, or the like. When ACK is received from the second terminal, the first terminal may determine that the data has been successfully received at the second terminal. When NACK is received from the second terminal, the first terminal may determine that the second terminal has failed to receive the data. In this case, the first terminal may transmit additional information to the second terminal based on an HARQ scheme. Alternatively, the first terminal may improve a reception probability of the data at the second terminal by retransmitting the same data to the second terminal.

When the broadcast scheme is used, a procedure for transmitting feedback information for data may not be performed. For example, system information may be transmitted in the broadcast scheme, and the terminal may not transmit feedback information for the system information to the base station. Therefore, the base station may not identify whether the system information has been successfully received at the terminal. To solve this problem, the base station may periodically broadcast the system information.

When the groupcast scheme is used, a procedure for transmitting feedback information for data may not be performed. For example, necessary information may be periodically transmitted in the groupcast scheme, without the procedure for transmitting feedback information. However, when the candidates of terminals participating in the groupcast scheme-based communication and/or the number of the terminals participating in that is limited, and the data transmitted in the groupcast scheme is data that should be received within a preconfigured time (e.g., data sensitive to delay), it may be necessary to transmit feedback information also in the groupcast sidelink communication. The groupcast sidelink communication may mean sidelink communication performed in the groupcast scheme. When the feedback information transmission procedure is performed in the groupcast sidelink communication, data can be transmitted and received efficiently and reliably.

In the groupcast sidelink communication, two HARQ-ACK feedback schemes (i.e., transmission procedures of feedback information) may be supported. When the number of receiving terminals in a sidelink group is large and a service scenario 1 is supported, some receiving terminals belonging to a specific range within the sidelink group may transmit NACK through a PSFCH when data reception fails. This scheme may be a groupcast HARQ-ACK feedback option 1. In the service scenario 1, instead of all the receiving terminals in the sidelink group, it may be allowed for some receiving terminals belonging to a specific range to perform reception in a best-effort manner. The service scenario 1 may be an extended sensor scenario in which some receiving terminals belonging to a specific range need to receive the same sensor information from a transmitting terminal. In exemplary embodiments, the transmitting terminal may refer to a terminal transmitting data, and the receiving terminal may refer to a terminal receiving data.

When the number of receiving terminals in the sidelink group is limited and a service scenario 2 is supported, each of all the receiving terminals belonging to the sidelink group may report HARQ-ACK for data individually through a separate PSFCH. This scheme may be a groupcast HARQ-ACK feedback option 2. In the service scenario 2, since PSFCH resources are sufficient, the transmitting terminal may perform monitoring on HARQ-ACK feedbacks of all the receiving terminals belonging to the sidelink group, and data reception may be guaranteed at all the receiving terminals belonging to the sidelink group.

As in broadcast sidelink communication, data may be transmitted and received without an HARQ-ACK feedback procedure in unicast sidelink communication and groupcast sidelink communication. In this case, in order to increase a probability of receiving the data, a transmitting terminal may retransmit the data a preset number of times.

In all transmission schemes (e.g., unicast transmission, groupcast transmission, and broadcast transmission), whether an HARQ-ACK feedback procedure is applied may be statically or semi-statically configured to the terminal(s) by signaling (e.g., system information signaling, PC5-RRC signaling, UE-specific RRC signaling, control information signaling). In sidelink communication, HARQ-ACK feedback information may be transmitted on a PSFCH.

If reception of a PSSCH is successful, a receiving terminal may transmit ACK for the PSSCH (e.g., data) on the PSFCH. If reception of the PSSCH fails, the receiving terminal may transmit NACK for the PSSCH (e.g., data) on the PSFCH. The PSFCH may be a channel for reporting ACK/NACK information (e.g., HARQ-ACK feedback) to the transmitting terminal. A resource region (e.g., PSFCH resource region) for PSFCH transmission (e.g., transmission of HARQ-ACK feedback) may be preconfigured within a specific resource pool. The PSFCH (e.g., PSFCH resource or PSFH resource region) may be configured periodically. A PSFCH periodicity for the PSFCH resource may be k slots (e.g., logical sidelink (SL) slots). k may be a natural number. For example, k may be 1, 2, or 4.

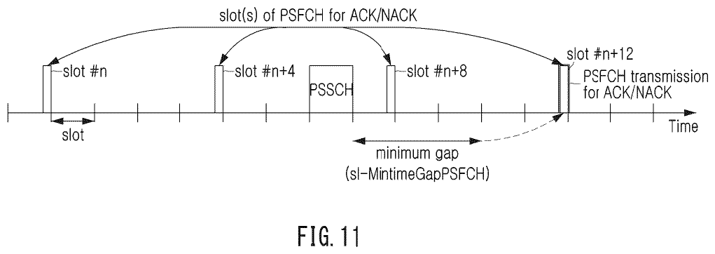

FIG. 10 is a conceptual diagram illustrating exemplary embodiments of configuration of a slot in which a PSFCH is configured.

Referring to FIG. 10, a PSFCH (e.g., HARQ-ACK feedback) may be repeatedly transmitted in two symbols (e.g., two OFDM symbols) within a slot (e.g., SL slot). The first symbol among two symbols in which the PSFCH is transmitted may be used for automatic gain control (AGC) for correct PSFCH receive power level adjustment.

The PSFCH may be transmitted within a frequency resource region preconfigured by system information. In this case, the frequency resource region for PSFCH transmission may be indicated (e.g., signaled) in form of a bitmap within the resource pool. The receiving terminal may implicitly select a location of the frequency resource region for PSFCH transmission based on indexes of a slot and a subchannel in which a PSSCH is received. The receiving terminal may identify the number of resource blocks (RBs) and the number of PSFCH resources multiplexable based on cyclic shifts of a PSFCH sequence within the frequency resource region. The receiving terminal may implicitly select a PSFCH index for PSFCH resource(s) based on a source identifier (ID) and a member ID. The source ID may be a physical layer source ID. The source ID may be an ID of a transmitting terminal that has transmitted the PSSCH.

The member ID may be used in the groupcast HARQ-ACK feedback option 2. When the groupcast HARQ-ACK feedback option 2 is applied, each of all receiving terminals within a group may individually transmit an HARQ-ACK feedback for SL data through a separate PSFCH (e.g., PSFCH resource). In a case other than the above-described exemplary embodiment, the member ID may be set to 0.

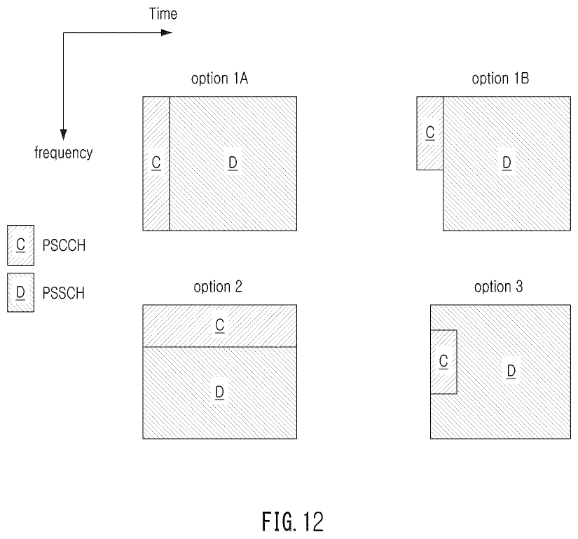

FIG. 11 is a conceptual diagram illustrating exemplary embodiments of a PSFCH for ACK/NACK transmission.

Referring to FIG. 11, a transmission time of a PSFCH may be the first slot (e.g., PSFCH slot) in which PSFCH transmission is possible after a preset time (e.g., sl-MinTimeGapPSFCH) from a reception time of a corresponding PSSCH. The PSFCH slot may be a slot capable of transmitting a PSFCH and/or a slot in which a PSFCH is configured. sl-MinTimeGapPSFCH may be set in consideration of a time required for processing the PSSCH after reception of the PSSCH and a time required for preparing for ACK/NACK (e.g., HARQ-ACK feedback) depending on whether reception of the PSSCH is successful. sl-MinTimeGapPSFCH may be set to 2 or 3 slots. The terminal (e.g., receiving terminal) may transmit the PSFCH in a slot #n+12, which is a slot capable of PSFCH transmission, after sl-MinTimeGapPSFCH (e.g., 3 slots) from a reception time of the PSSCH. n may be an integer greater than or equal to 0. In the present disclosure, the reception time may mean a reception start time and/or a reception end time, and the transmission time may mean a transmission start time and/or a transmission end time. The time may mean a timing and/or duration.

Data reliability at the receiving terminal may be improved by appropriately adjusting a transmit power of the transmitting terminal according to a transmission environment. Interference to other terminals may be mitigated by appropriately adjusting the transmit power of the transmitting terminal. Energy efficiency can be improved by reducing unnecessary transmit power. A power control scheme may be classified into an open-loop power control scheme and a closed-loop power control scheme. In the open-loop power control scheme, the transmitting terminal may determine the transmit power in consideration of configuration, a measured environment, etc. In the closed-loop power control scheme, the transmitting terminal may determine the transmit power based on a transmit power control (TPC) command received from the receiving terminal.

It may be difficult due to various causes including a multipath fading channel, interference, and the like to predict a received signal strength at the receiving terminal. Accordingly, the receiving terminal may adjust a receive power level (e.g., receive power range) by performing an automatic gain control (AGC) operation to prevent a quantization error of the received signal and maintain a proper receive power. In the communication system, the terminal may perform the AGC operation using a reference signal received from the base station. However, in the sidelink communication (e.g., V2X communication), the reference signal may not be transmitted from the base station. That is, in the sidelink communication, communication between terminals may be performed without the base station. Therefore, it may be difficult to perform the AGC operation in the sidelink communication. In the sidelink communication, the transmitting terminal may first transmit a signal (e.g., reference signal) to the receiving terminal before transmitting data, and the receiving terminal may adjust a receive power range (e.g., receive power level) by performing an AGC operation based on the signal received from the transmitting terminal. Thereafter, the transmitting terminal may transmit sidelink data to the receiving terminal. The signal used for the AGC operation may be a signal duplicated from a signal to be transmitted later or a signal preconfigured between the terminals.

A time period required for the ACG operation may be 15 μs. When a subcarrier spacing of 15 kHz is used in the NR system, a time period (e.g., length) of one symbol (e.g., OFDM symbol) may be 66.7 μs. When a subcarrier spacing of 30 kHz is used in the NR system, a time period of one symbol (e.g., OFDM symbol) may be 33.3 μs. In the following exemplary embodiments, a symbol may mean an OFDM symbol. That is, a time period of one symbol may be twice or more than a time period required for the ACG operation.

For sidelink communication, it may be necessary to transmit a data channel for data transmission and a control channel including scheduling information for data resource allocation. In sidelink communication, the data channel may be a physical sidelink shared channel (PSSCH), and the control channel may be a physical sidelink control channel (PSCCH). The data channel and the control channel may be multiplexed in a resource domain (e.g., time and frequency resource domains).

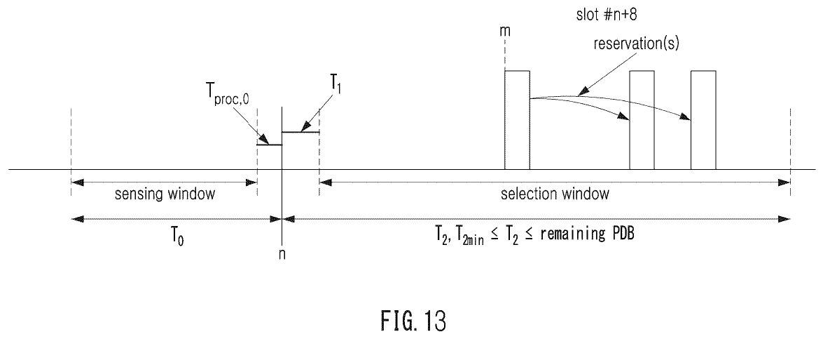

FIG. 12 is a conceptual diagram illustrating exemplary embodiments of a method for multiplexing a control channel and a data channel in sidelink communication.

Referring to FIG. 12, sidelink communication may support an option 1A, an option 1B, an option 2, and an option 3. When the option 1A and/or the option 1B is supported, a control channel and a data channel may be multiplexed in the time domain. When the option 2 is supported, a control channel and a data channel may be multiplexed in the frequency domain. When the option 3 is supported, a control channel and a data channel may be multiplexed in the time and frequency domains. The sidelink communication may basically support the option 3.

In the sidelink communication (e.g., NR-V2X sidelink communication), a basic unit of resource configuration may be a subchannel. The subchannel may be defined with time and frequency resources. For example, the subchannel may be composed of a plurality of symbols (e.g., OFDM symbols) in the time domain, and may be composed of a plurality of resource blocks (RBs) in the frequency domain. The subchannel may be referred to as an RB set. In the subchannel, a data channel and a control channel may be multiplexed based on the option 3.

In the sidelink communication (e.g., NR-V2X sidelink communication), transmission resources may be allocated based on a mode 1 or a mode 2. When the mode 1 is used, a base station may allocate sidelink resource(s) for data transmission within a resource pool to a transmitting terminal, and the transmitting terminal may transmit data to a receiving terminal using the sidelink resource(s) allocated by the base station. Here, the transmitting terminal may be a terminal that transmits data in sidelink communication, and the receiving terminal may be a terminal that receives the data in sidelink communication.

When the mode 2 is used, a transmitting terminal may autonomously select sidelink resource(s) to be used for data transmission by performing a resource sensing operation and/or a resource selection operation within a resource pool. The base station may configure the resource pool for the mode 1 and the resource pool for the mode 2 to the terminal(s). The resource pool for the mode 1 may be configured independently from the resource pool for the mode 2. Alternatively, a common resource pool may be configured for the mode 1 and the mode 2.

When the mode 1 is used, the base station may schedule a resource used for sidelink data transmission to the transmitting terminal, and the transmitting terminal may transmit sidelink data to the receiving terminal by using the resource scheduled by the base station. Therefore, a resource conflict between terminals may be prevented. When the mode 2 is used, the transmitting terminal may select an arbitrary resource by performing a resource sensing operation and/or resource selection operation, and may transmit sidelink data by using the selected arbitrary resource. Since the above-described procedure is performed based on an individual resource sensing operation and/or resource selection operation of each transmitting terminal, a conflict between selected resources may occur.

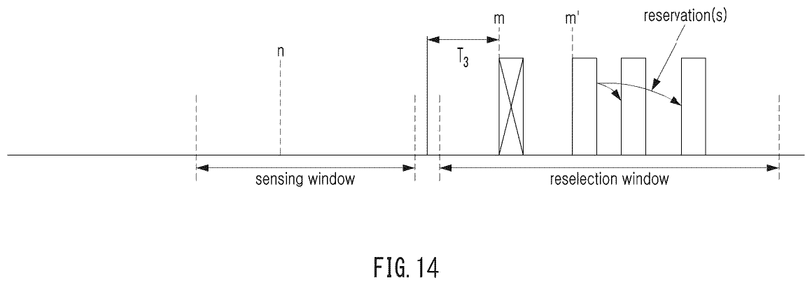

FIG. 13 is a conceptual diagram illustrating exemplary embodiments of a resource selection operation.

Referring to FIG. 13, a terminal (e.g., transmitting terminal) may perform a resource sensing operation within a sensing window, and may perform a resource selection operation on resource(s) (e.g., candidate resource(s)) sensed within the selection window. When the resource selection operation is triggered at a time n, the terminal may select suitable resource(s) within the selection window (e.g., a period from a time n+T₁ to a time n+T₂) based on a result of the sensing within the sensing window (e.g., a period from a time n-T₀ to a time n-T_{proc,0}).

Based on the result of the resource sensing operation, the terminal may exclude candidate resource(s) that do not satisfy a condition within the selection window. In other words, the terminal may determine the remaining candidate resources excluding the candidate resource(s) that are not suitable from all candidate resources. When a ratio of the remaining candidate resources among all resources within the selection window is less than a reference ratio, the terminal may relax the condition for excluding the candidate resource(s). For example, the terminal may increase a reference signal received power (RSRP) threshold, which is the condition for excluding candidate resource(s), by 3 dB. Thereafter, the terminal may perform the resource selection operation again. The reference ratio may be preset to one of 20%, 35%, or 50% for each priority. When the ratio of the remaining candidate resources is greater than or equal to the reference ratio, the terminal may randomly select final resource(s) to be used for SL transmission among the remaining candidate resources. The terminal may perform SL transmission using the final resource(s).

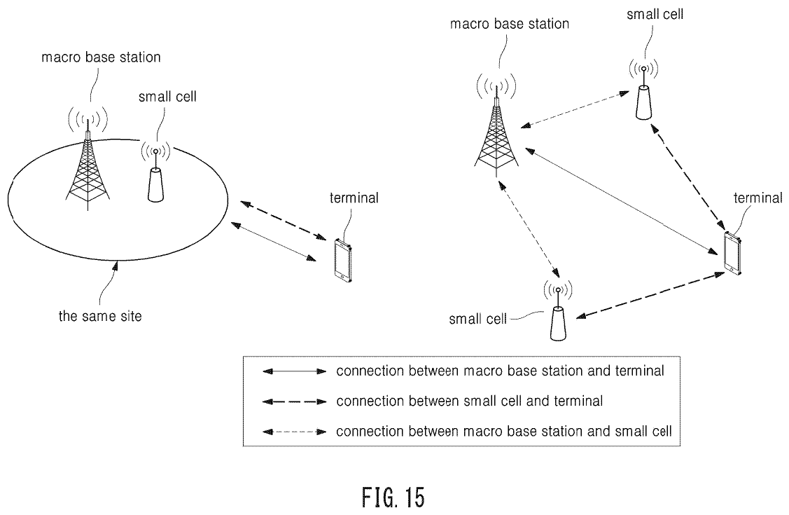

FIG. 14 is a conceptual diagram illustrating exemplary embodiments of a resource reselection operation.

Referring to FIG. 14, after the resource selection operation, the terminal may perform a resource reselection operation in consideration of aperiodic data transmission or the like. After performing the operations shown in FIG. 13, the terminal may perform the resource reselection operation by additionally considering a result of sensing at a time m-T₃ before actual SL transmission. The resource reselection operation may be performed within a reselection window. The terminal may further determine suitability of resource(s) reserved at the time m. When it is determined that the resource(s) reserved in the time m is suitable, the terminal may perform SL transmission using the reserved resource(s). When it is determined that the resource(s) reserved at the time m is not suitable, the terminal may reselect resource(s) for SL transmission and perform SL transmission using the reselected resource(s).

When an independent SL carrier is not configured for SL communication, some UL resources among UL resources may be configured as SL resources by an SL resource pool configuration procedure. A bitmap may be repeatedly applied to the remaining slot(s) excluding slot(s) in which at least X or more UL symbols are not configured and slot(s) in which a sidelink(S)-SSB is transmitted among slots within a specific period. X may be a natural number. The bitmap may indicate slot(s) used as SL resources. For example, slot(s) corresponding to bit(s) set to 1 among bits in the bitmap may be used as SL resources

A case in which a 15 kHz subcarrier spacing (SCS) is applied and X or more UL symbols are configured in all slots may be assumed. When there are 10240 slots available within a direct frame number (DFN), a transmission periodicity of the S-SSB is 160 ms, and there are 2 slots used for S-SSB transmission in each S-SSB transmission period, the number of slots used for S-SSB transmission within a DFN may be 128. A bitmap for configuring SL time resources may include 10 bits. When the bitmap (e.g., bitmap including 10 bits) is repeatedly applied to the remaining 10112 slots excluding 128 slots used for S-SSB transmission among 10240 slots, there may be two slots (e.g., reserved slots) to which the bitmap is not applied. It may be necessary to exclude the two reserved slots. When excluding the two reserved slots from 10112 slots, 10110 slots may remain. The bitmap (e.g., bitmap including 10 bits) may be repeatedly applied 1011 times to 10110 slots. When the bitmap is set to ‘1111000000’ and slots corresponding to bits set to 1 are used as SL resources, 4044 slots may be configured as SL resources within the DFN. In other words, 4044 slots among 10240 slots may be used for SL communication by configuring the SL resource pool.

The sidelink communication system supporting Release-16 may be designed for terminals (e.g., vehicle-mounted terminals, vehicle UEs (V-UEs)) that do not have restrictions on battery capacity. Therefore, a power saving issue may not be greatly considered in resource sensing/selection operations for such the terminals. However, in order to perform sidelink communication with terminals having restrictions on battery capacity in the sidelink communication system supporting Release-17 (e.g., a terminal carried by a pedestrian, a terminal mounted on a bicycle, a terminal mounted on a motorcycle, a pedestrian UE (P-UE)), power saving methods will be required. In the present disclosure, a ‘V-UE’ may refer to a terminal that has no significant restrictions on battery capacity, a ‘P-UE’ may refer to a terminal with restrictions on battery capacity, and a ‘resource sensing/selection operation’ may refer to a resource sensing operation and/or a resource selection operation. The resource sensing operation may refer to a partial sensing operation or a full sensing operation. The resource selection operation may refer to a random selection operation. In addition, in the present disclosure, an ‘operation of a terminal’ may be interpreted as an ‘operation of a V-UE’ and/or ‘operation of a P-UE’.

For power saving in the LTE V2X, a partial sensing operation and/or a random selection operation has been introduced. When the partial sensing operation is supported, the terminal may perform resource sensing operations in partial periods instead of an entire period within a sensing window, and may select a resource based on a result of the partial sensing operation. According to such the operation, power consumption of the terminal may be reduced.

In the Release-14 LTE V2X, only periodic data transmission and reception operations may be possible. In the Release-14 LTE V2X, the terminal may arbitrarily select candidate slots within a resource selection period (e.g., selection window) in consideration of a preset minimum number, and perform a partial sensing operation in consideration of a periodicity of k×100 ms. k may be signaled by a bitmap (e.g., bitmap including 10 bits). k may be determined according to a position of a bit included in the bitmap. For example, 10 bits included in the bitmap may respectively correspond to values from 1 to 10 from the MSB, and the periodicity may be determined based on a value corresponding to a bit set to 1. The value corresponding to the bit set to 1 may be k.

When the MSB is set to 1 in the bitmap, k may be 1. In this case, the terminal may perform a partial sensing operation in consideration of a periodicity of 100 ms (=1×100 ms).

When a bit next to the MSB in the bitmap is set to 1, k may be 2. In this case, the terminal may perform a partial sensing operation in consideration of a periodicity of 200 ms (=2×100 ms). When the LSB is set to 1 in the bitmap, k may be 10. In this case, the terminal may perform a partial sensing operation in consideration of a periodicity of 1000 ms (=10× 100 ms).

In the Release-14 LTE V2X, the periodicity (e.g., the periodicity of partial sensing operation) may be set to 20 ms or 50 ms. A periodicity of 20 ms or 50 ms may not be supported in a resource pool for a P-UE. In the NR communication system, a shorter periodicity may be supported in addition to {0, 100 ms, 200 ms, . . . , 1000 ms}. The short periodicity may be {1 ms, 2 ms, . . . , 99 ms}. Up to 16 periodicities may be selected from the resource pool, and the selected periodicities may be preconfigured to the terminal. The terminal may perform the resource sensing operation and/or the resource (re) selection operation using one or more of the configured periodicities. When a random selection operation is supported, the terminal may randomly select a resource without performing a resource sensing operation. Alternatively, the random selection operation may be performed together with the resource sensing operation. For example, the terminal may determine resources by performing the resource sensing operation, and may select resource(s) by performing the random selection operation within the determined resources.

In the LTE V2X supporting Release-14, a resource pool in which the partial sensing operation and/or random selection operation can be performed may be configured independently of a resource pool in which the full sensing operation can be performed. A resource pool capable of performing the random selection operation, a resource pool capable of performing the partial sensing operation, and a resource pool capable of performing the full sensing operation may be independently configured. In other words, a random selection operation, a partial sensing operation, or both a random selection operation and a partial sensing operation may be configured for each resource pool. When both a random selection operation and a partial sensing operation are configured for a resource pool, the terminal may select one operation among the random selection operation and the partial sensing operation, select a resource by performing the selected operation, and use the selected resource to perform SL communication.

In the LTE V2X supporting Release-14, sidelink (SL) data may be periodically transmitted based on a broadcast scheme. In the NR communication system, SL data may be transmitted based on a broadcast scheme, multicast scheme, groupcast scheme, or unicast scheme. In addition, in the NR communication system, SL data may be transmitted periodically or aperiodically. A transmitting terminal may transmit SL data to a receiving terminal, and the receiving terminal may transmit an HARQ feedback (e.g., acknowledgement (ACK) or negative ACK (NACK)) for the SL data to the transmitting terminal on a PSFCH. In the present disclosure, a transmitting terminal may refer to a terminal transmitting SL data, and a receiving terminal may refer to a terminal receiving the SL data.

A terminal having reduced capability (hereinafter, referred to as ‘RedCap terminal’) may operate in a specific usage environment. The capability of the RedCap terminal may be lower than capability of a new radio (NR) normal terminal, and may be higher than those of an LTE-machine type communication (LTE-MTC) terminal, a narrow band (NB)-Internet of things (IoT) terminal, and a low power wide area (LPWA) terminal. For example, a terminal (e.g., surveillance camera) requiring a high data rate and not high latency condition and/or a terminal (e.g., wearable device) requiring a non-high data rate, high latency condition, and high reliability may exist. In order to support the above-described terminals, the maximum carrier bandwidth in FR1 may be reduced from 100 MHz to 20 MHZ, and the maximum carrier bandwidth in FR2 may be reduced from 400 MHz to 100 MHz. The number of reception antennas of the RedCap terminal may be smaller than the number of reception antennas of the NR normal terminal. When the carrier bandwidth and the number of reception antennas are reduced, reception performance at the RedCap terminal may decrease, and accordingly, the coverage of the RedCap terminal may decrease.

The communication system (e.g., NR system) may operate in a frequency band higher than a 52.6 GHz frequency band. As a frequency of the frequency band in which the communication system operates increases, a frequency offset error and a phase noise may increase. The use of a large SCS may be necessary for robust operations in such a environment. In an FR2 band, a 60 kHz SCS and/or a 120 kHz SCS may be supported, and a 480 kHz SCS and/or a 960 kHz SCS may be additionally supported. In addition, design of physical layer signals and channels and physical layer procedures according to the new SCSs may be required. Regarding an initial access procedure, 120 kHz SSBs and/or 240 kHz SSBs may be supported in an FR2 band, and 480 kHz SSBs and/or 960 kHz SSBs may be additionally supported. Here, the 120 kHz SSB may refer to an SSB transmitted in a radio resource to which the 120 kHz SCS is applied, and the 240 kHz SSB may refer to an SSB transmitted in a radio resource to which the 240 kHz SCS is applied. A method for configuring an initial BWP and an SSB burst set pattern for supporting the new SCSs may be required.

The communication system may support network energy saving (NES) techniques. For NES techniques, techniques in the time domain, techniques in the frequency domain, techniques in the spatial domain, and/or techniques in the power domain may be required. The techniques in the time domain may include SSB-less secondary cell (SCell) operations and/or cell discontinuous transmission/discontinuous reception (DTX/DRX) operations. To support NES techniques, on-demand SSB transmission technique and on-demand system information (SI) transmission technique may be required.

If access to an additional small cell (e.g., SCell) is required when there is a lot of downlink data to be transmitted to the terminal, when resources for transmission of a lot of downlink data are requested from the terminal, and/or for other purposes, SSB transmission by the small cell may be requested by a macro base station (e.g., macro cell, primary cell (PCell)). In the present disclosure, a macro base station may refer to a base station (e.g., cell) other than a small cell. In other words, a macro base station may be a term used to distinguish it from a small cell, and a macro base station may be a general term for a base station (e.g., cell) that is not a small cell. A small cell may refer to a cell (e.g., base station) that is not a macro base station. In other words, a small cell may be a term used to distinguish it from a macro base station, and a small cell may be a general term for a cell (e.g., base station) that is not a macro base station.

Operations and/or configurations of a macro base station may be performed by a small cell in the same or similar manner. Alternatively, operations and/or configurations of a small cell may be performed by a macro base station in the same or similar manner. A base station may refer to a macro base station and/or small cell. In other words, operations/configurations of a base station may be interpreted as operations/configurations of a macro base station, operations/configurations of a small cell, or operations/configurations of a macro base station and a small cell depending on a context. A macro base station may be referred to as a first base station (e.g., first cell), and a small cell may be referred to as a second base station (e.g., second cell). Alternatively, a macro base station may be referred to as a second base station (e.g., second cell), and a small cell may be referred to as a first base station (e.g., first cell).

If a terminal is required to access a small cell due to the terminal's needs, the terminal may request SSB transmission from the small cell through a macro base station. The small cell may transmit SSB(s) upon the request by the macro base station and/or terminal. The SSB transmitted at the request of the base station and/or terminal may be an on-demand SSB. The terminal may perform an access procedure for the small cell based on the SSB received from the small cell. When the terminal is connected to the small cell, a base station (e.g., macro base station) associated with the small cell may not transmit SSBs to save energy. In the above-described situation, while the terminal performs communication (e.g., signal and/or channel transmission and reception operations) without SSB, the terminal may request SSB transmission for downlink resynchronization. The small cell may transmit SSB(s) at the request by the macro base station and/or terminal. The terminal may perform a synchronization procedure based on the SSB received from the small cell. In this case, the terminal may request SSB transmission from the small cell through the macro base station by using an uplink signal and/or channel (e.g., PRACH, PUCCH, PUSCH, SRS, etc.). The macro base station may receive an SSB transmission request from the terminal, and forward the SSB transmission request to the small cell through a backhaul link. The small cell may receive the SSB transmission request, and transmit SSB(s) based on the SSB transmission request.

As another method, the terminal may request SSB transmission from the small cell through an uplink signal and/or channel (e.g., PRACH, PUCCH, PUSCH, SRS, etc.). The uplink signal and/or channel requesting SSB transmission may be transmitted to the macro base station, the macro base station may deliver information requesting SSB transmission to the small cell, the small cell may receive the uplink signal and/or channel requesting SSB transmission from the macro base station, and transmit SSB(s) according to the request. Alternatively, the uplink signal and/or channel requesting SSB transmission may be transmitted directly from the terminal to the small cell, and the small cell may transmit SSB(s) at the request of the terminal.

When the terminal requests SSB transmission, a trigger signal for the SSB transmission request may be separate indication information included in the uplink signal and/or channel. For example, in a PRACH requesting SSB transmission, a PRACH preamble may be indication information that is explicit information requesting SSB transmission. A buffer status report (BSR) transmitted on a PUSCH requesting SSB transmission may be implicit indication information requesting SSB transmission. In other words, the SSB transmission request may be indicated by explicit and/or implicit scheme.

As another method, the terminal may request SSB transmission using an SCell activation/deactivation indicator. The SCell activation/deactivation indicator is an indicator used to inform the terminal of activation or deactivation of an SCell, but in a similar manner, the terminal may request SSB transmission by reporting (e.g., transmitting) the SCell activation/deactivation indicator to the base station. For example, the SCell activation indicator may be used to request SSB transmission. To request SSB transmission from a small cell, the terminal may need to exist within an area (e.g., coverage) of the small cell. The macro base station and the small cell may be connected through an X2 interface, and coordination between the macro base station and the small cell may be possible based on the connection.

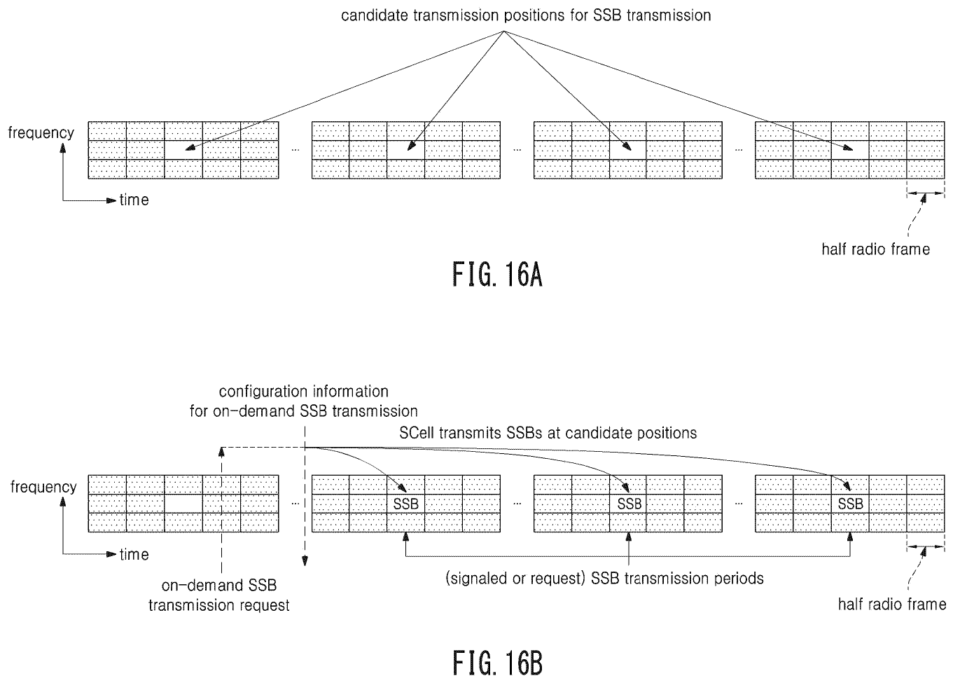

FIG. 15 is a conceptual diagram illustrating deployment scenarios of a communication system.

Referring to FIG. 15, a macro base station (e.g., first base station, first cell) may mainly operate in a frequency range below 6 GHz and cover a wide coverage. A small cell (e.g., second base station, second cell) may mainly operate in a frequency range above 6 GHz and may cover a smaller coverage than the macro base station. The small cell may have a wide system bandwidth and may transmit and receive large amounts of data using the wide system bandwidth. An interface may be established between the macro base station and the small cell, and mutual cooperation between the macro base station and the small cell may be possible based on the interface. The terminal may be able to be simultaneously connected with the macro base station and the small cell. In a deployment scenario shown in FIG. 15, a transmission procedure of an aperiodic on-demand SSB of the small cell at the request of the macro base station, small cell, and/or terminal may be performed as follows.

### 1. Request for Transmission of Terminal-Related Information Required for Small Cell SSB Transmission

In a situation where the terminal accesses the macro base station and maintains connection with the macro base station, the terminal may need to additionally access the small cell. In this case, the small cell may transmit SSB(s) for time and/or frequency synchronization of the terminal with the small cell. In this case, the macro base station may request the terminal to report terminal-related information (e.g., UE capability-related information) required for SSB transmission of the small cell. The terminal-related information may be as follows. The terminal may report terminal-related information (e.g., one or more pieces of information belonging to an information set 1 below) to the macro base station at the request of the macro base station. The macro base station may receive the terminal-related information from the terminal. The macro base station may deliver the terminal-related information to the small cell. The small cell may receive the terminal-related information from the macro base station. The information set 1 may include at least one information among information 1-A or information 1-B. The information set 1 may include information other than the information 1-A and the information 1-B.

### <Information Set 1>

Information 1-A: The number of reception beams of the terminal
Information 1-B: Information related to SSB transmission period(s) (e.g., SSB transmission periodicity)

The information 1-A may be information necessary to determine the number of SSB transmissions so that the terminal detects, through all reception beams of the terminal, SSB(s) transmitted in a beam sweeping scheme. The information 1-A may be replaced with the number of SSB transmissions requested by the terminal regardless of the number of reception beams of the terminal. In other words, the information 1-A may represent the number of SSB transmission periods (e.g., SSB transmission cycles) indicating over how many cycles a plurality of SSBs transmitted through beam sweeping are transmitted. The terminal may report the information 1-A to the macro base station.

The terminal may report appropriate information 1-B (e.g., information on the SSB transmission period(s), information on the SSB transmission periodicity) according to a processing power of the terminal. For example, the terminal may select one SSB transmission period among selectable SSB transmission periods (e.g., candidate SSB transmission periods, candidate SSB transmission periodicities) and report the selected one SSB transmission period. In the present disclosure, an SSB transmission period may mean an SSB transmission periodicity (e.g., period according to the SSB transmission periodicity). In other words, an SSB transmission period may be interpreted as an SSB transmission periodicity depending on a context.

The terminal may report the terminal-related information (e.g., information 1-A and/or information 1-B) along with SSB transmission trigger information to the macro base station through an uplink channel (e.g., PUCCH and/or PUSCH). Alternatively, the terminal may report the terminal-related information (e.g., information 1-A and/or information 1-B) separately from the SSB transmission trigger information to the macro base station through an uplink channel (e.g., PUCCH and/or PUSCH). The terminal-related information may be reported at an initial stage when the terminal accesses the macro base station. Alternatively, when the terminal needs to access the small cell, the macro base station may request the terminal to report terminal-related information, and the terminal may report the terminal-related information based on the request. The macro base station may request the terminal to report the terminal-related information through signaling (e.g., UE-specific RRC signaling, MAC CE signaling, DCI signaling).

2. The Macro Base Station May Complete SSB Transmission Configuration Based on the Terminal-Related Information, Deliver SSB Transmission Configuration Information to the Terminal, and Indicate the Small Cell to Transmit SSB(s) According to the SSB Transmission Configuration Information.

The macro base station may configure an environment related to SSB transmission of the small cell based on the terminal-related information received from the terminal. In other words, the macro base station may complete SSB transmission configuration based on the terminal-related information received from the terminal. The macro base station may transmit SSB transmission configuration information to the small cell. The small cell may receive the SSB transmission configuration information from the macro base station.

As another method, the macro base station may configure the environment related to SSB transmission of the small cell without receiving terminal-related information from the terminal. In other words, the macro base station may complete SSB transmission configuration based on information possessed by the macro base station. The macro base station may transmit SSB transmission configuration information to the small cell. The small cell may receive the SSB transmission configuration information from the macro base station.

As another method, the small cell may receive the terminal-related information from the macro base station and configure an environment related to SSB transmission based on the terminal-related information. The macro base station and/or small cell may set the number of SSB transmission periods (e.g., the number of SSB burst sets) in which beam sweeping is performed based on the information 1-A. The macro base station and/or small cell may configure a periodicity of the SSB transmission periods based on the information 1-B. The macro base station and/or small cell may complete configuration of the environment for SSB transmission based on the terminal-related information (e.g., UE capability information) and may transmit the following information (e.g., one or more pieces of information belonging to an information set 2 below) to the terminal. The terminal may receive one or more pieces of information belonging to the information set 2 from the macro base station and/or small cell. The information set 2 may include at least one of information 2-A, information 2-B, information 2-C, information 2-D, information 2-E, information 2-F, information 2-G, information 2-H, or information 2-I. The information set 2 may include information other than the information 2-A to information 2-I. The information set 2 may be SSB transmission configuration information (e.g., on-demand SSB transmission configuration information). The information set 2 may be SSB transmission configuration information (e.g., on-demand SSB transmission configuration information) for SCell activation. The information set 2 may be information on small cell(s).

### <Information Set 2>

Information 2-A: Capability information of small cell(s), which includes at least one of cell identifier(s) (ID(s)), system bandwidth(s), numerology(ies), or antenna configuration(s)
Information 2-B: Beam sweeping information including at least one of the number of beams (e.g., the number of SSBs and/or the number of actually transmitted SSBs) or an order of the beams
Information 2-C: Timing information (e.g., timing offset)
Information 2-D: starting position of SSB transmission (e.g., SFN, half radio frame indicator, subframe index, slot index, and/or indication on whether the macro base station and the small cell is tightly synchronized or not)
Information 2-E: Time resources (e.g., time periods, transmission periodicity) and/or frequency resources for SSB transmission
Information 2-F: The number of SSB transmissions (e.g., number of SSB subframes and/or number of SSB burst sets based on the number of beams of the terminal)
Information 2-G: RACH Resources (if required)
Information 2-H: SSB transmission indication (e.g., SCell activation/deactivation)
Information 2-I: CSI configuration information (e.g., resource(s) for CSI reporting)

The information 2-A may be information on adjacent small cell(s) to which the terminal can access. The information 2-A may include at least one of cell ID(s), system bandwidth(s), numerology(ies) used in cell(s) (e.g., small cell(s)), or antenna configuration(s). The information 2-A may include information on the overall system of small cell(s).

The information 2-B may be beam sweeping information. The information 2-B may include at least one of the number of beams transmitting SSBs, the number of SSBs, or the beam sweeping order. The information 2-B may include information on the actually transmitted SSB(s) and/or beam sweeping information therefor.

The information 2-C may include timing-related information. The timing-related information may include a timing offset between the macro base station and the small cell, a transmission time point (e.g., transmission time) of on-demand SSB activation information, and/or a start time point (e.g., start time) of actual on-demand SSB transmission. The terminal may easily perform a synchronization operation between the terminal and the small cell based on the timing-related information (e.g., information 2-C).

The information 2-D may indicate a start time at which SSB(s) are actually transmitted by the small cell. The information 2-D may include at least one of an SFN, half radio frame indicator, subframe index, slot index, or half frame indicator. The information 2-D may include information indicating whether the macro base station and the small cell are synchronized. When it is indicated (e.g., signaled) that the macro base station and the small cell are synchronized, information on the position (e.g., SFN, subframe index, slot index) of the SSB transmitted by the small cell may be the same as information on the position (e.g., SFN, half radio frame indicator, subframe index, slot index) of the SSB transmitted by the macro base station. Alternatively, when it is indicated (e.g., signaled) that the macro base station and the small cell are synchronized, the terminal may derive information on the position (e.g., SFN, subframe index, slot index) of the SSB transmitted by the small cell based on a numerology ratio between the macro base station and the small cell. When it is indicated (e.g., signaled) that the macro base station and the small cell are not synchronized, the terminal may identify the position of the SSB transmitted by the small cell by performing an exhaustive search.

As another method, the small cell may transmit SSB(s) from the earliest SSB transmission time after a time of receiving the SSB transmission indication (e.g., SSB transmission request) from the macro base station. Position(s) in which SSB(s) can be transmitted (e.g., SSB transmission candidate time(s), SSB transmission occasion(s)) may be preconfigured (e.g., defined) for each SSB transmission periodicity. The small cell may perform SSB transmission from the earliest SSB transmission position (e.g., the earliest SSB transmission candidate position) according to the SSB transmission periodicity after the time of receiving the SSB transmission indication.

The information 2-E may be information on time resources (e.g., time period, transmission periodicity) and/or frequency resources through which SSB(s) are transmitted. In other words, the information 2-E may include time resource information and/or frequency resource information. The information on time resources (e.g., time period, transmission periodicity) may indicate a periodicity at which SSB(s) are transmitted. If the information 1-B reported by the terminal is valid, the macro base station may determine an SSB transmission periodicity (e.g., time resources (e.g., time period(s), transmission periodicity) in which SSB(s) are transmitted) based on the information 1-B. To reduce an access latency when the terminal newly accesses the small cell, a short SSB transmission periodicity may be selected. In other words, to reduce the access latency to the small cell, a short SSB transmission periodicity may be set. An SSB transmission periodicity for continuously performing time synchronization, frequency synchronization, and/or measurement for the small cell after the terminal accesses the small cell may be set to an appropriate value in consideration of the terminal's situation (e.g., mobility). Information on the SSB transmission periodicity may be transmitted to the terminal through signaling (e.g., SI signaling, UE-specific RRC signaling). The information on the SSB transmission periodicity may be signaled to the terminal from the macro base station and/or small cell. If the terminal does not report the information 1-B, the small cell may transmit SSB(s) based on default SSB transmission period(s) (e.g., default SSB transmission periodicity).

In the frequency domain, a plurality of SSB candidate transmission positions (e.g., a plurality of SSB transmission candidate frequencies) may exist. The frequency resource information may be information on one or more frequency resources (e.g., one or more frequency positions) among the frequency resources (e.g., frequency positions) through which SSB(s) are actually transmitted. The frequency resource information may include information on an SSB synchronization raster and/or information on an absolute radio frequency channel number (ARFCN). SSB transmissions other than SSB transmission for initial access may be possible at frequency positions (e.g., frequency position corresponding to the ARFCN value) other than the SSB synchronization raster. In this case, the terminal may consider an SSB received at the frequency position corresponding to the ARFCN value as a non-cell defining SSB rather than a cell defining SSB. In other words, on-demand SSBs may be transmitted at frequency positions other than the SSB synchronization raster. The on-demand SSBs received at frequency positions other than the SSB synchronization raster may be non-cell defining SSBs.

As another method, although an SSB may be transmitted at the SSB synchronization raster, but a PBCH included in the SSB may indicate that there is no RMSI associated with the SSB. If the PBCH included in the SSB received at the SSB synchronization raster indicates that there is no RMSI associated with the SSB, the terminal may regard the SSB as a non-cell defining SSB. The above-described operation (e.g., operation of interpreting the SSB) may be configured in advance.

An MIB (e.g., MIB included in a cell-defining SSB) may include a barring indicator. The size of the barring indicator may be 1 bit. SSB transmissions other than SSB transmission for initial access may be indicated by the barring indicator. For example, a barring indicator set to a first value (e.g., 0) may indicate that an SSB including the barring indicator is an SSB for initial access. A barring indicator set to a second value (e.g., 1) may indicate that an SSB including the barring indicator is an SSB other than an SSB for initial access. In this case, a terminal capable of on-demand SSB reception may receive RMSI regardless of the value of the barring indicator included in the MIB (or regardless of whether the MIB includes the barring indicator), and may decide whether to bar SSB(s) (e.g., small cell) based on the indicator (e.g., 1-bit indicator, barring indicator) included in the RMSI. In other words, a terminal capable of on-demand SSB reception may decide whether to access the small cell based on the barring indicator included in the RMSI instead of the barring indicator included in the MIB. The RMSI may be received from the small cell. The barring indicator may be used to block legacy terminals from accessing the small cell.

The information 2-F may be information indicating the number of SSB transmission periods when the small cell transmits SSB(s) using a beam sweeping scheme. The macro base station may identify the number of reception beams of the terminal based on the information 1-A, identify all reception beams based on the number of reception beams of the terminal, and configure the information 2-F (e.g., the number of SSB transmissions) so that the SSB(s) are received through all the reception beams. Alternatively, the macro base station may configure the information 2-F based on a value requested by the terminal through the information 1-A.

As another method, a range for the number of SSB transmissions (e.g., a range for the number of SSB subframes, a range for the number of SSB burst sets) may be preset (e.g., fixed), and the base station (e.g., macro base station and/or small cell) may set the number of SSB transmissions to a specific value within the preset range. In other words, the base station (e.g., macro base station and/or small cell) may determine the number of SSB transmissions within the preset range in an implementation manner. The information 2-F may be information on a termination time (e.g., ending time) of SSB transmission associated with the information 2-D (e.g., start position (e.g., start time) of SSB transmissions) rather than the number of SSB transmission periods (e.g., SSB transmission periodicity). Alternatively, if the number of SSB transmission periods and/or the termination time of SSB transmissions is not separately set (e.g., signaled), the started SSB transmissions may continue to be performed until the base station (e.g., macro base station and/or small cell) stops the SSB transmissions.

After the base station (e.g., macro base station and/or small cell) completes SSB transmission configuration, the base station may notify the terminal of an indication that the small cell is to actually perform SSB transmission. The indication that the small cell is to actually perform SSB transmission may be delivered to the terminal through the macro base station. Alternatively, the indication that the small cell is to actually perform SSB transmission may be directly delivered to the terminal through the small cell. The SSB transmission configuration information (e.g., on-demand SSB transmission configuration information) may implicitly indicate that the small cell is to actually perform SSB transmission. The terminal may implicitly confirm that the small cell is to actually perform SSB transmission (e.g., on-demand SSB transmission) based on the SSB transmission configuration information received from the base station.

As another method, the base station may use a separate indicator to explicitly indicate that the small cell is to perform on-demand SSB transmission (e.g., actual SSB transmission). For example, the base station may indicate to the terminal that the small cell is to perform (e.g., starts) on-demand SSB transmission, through a separate PDCCH. The base station may indicate to the terminal that the small cell is to perform on-demand SSB transmission through an SCell activation/deactivation indicator using a MAC CE. If the SCell activation/deactivation indicator delivered to the terminal indicates activation of an SCell corresponding to the small cell (e.g., base station other than the macro base station) transmitting on-demand SSB, the terminal may determine that SSB transmission is to start by the small cell. The terminal may determine that the small cell is to start SSB transmission at the earliest SSB transmission occasion after a time of receiving the indicator (e.g., separate indicator, SCell activation/deactivation indicator). Alternatively, the terminal may receive the indicator (e.g., separate indicator, SCell activation/deactivation indicator), transmit a feedback (e.g., ACK/NACK) for the indicator, and determine that the small cell is to start SSB transmission in the earliest SSB transmission occasion after a time of transmitting the feedback.

After downlink synchronization for the small cell is acquired, the base station may transmit the information 2-G including information on resources required for RACH transmission for uplink synchronization, etc. to the terminal. The terminal may receive the information 2-G from the base station. The RACH resource information may be information on contention based random access (CBRA) resources and/or contention free random access (CFRA) resources. The RACH resource information may be information on a specific RACH resource allocated only to the terminal. If the specific RACH resource (e.g., CFRA resource) is allocated to the terminal, the terminal may perform a CFRA procedure. If the CFRA procedure is performed, an additional terminal identification procedure and/or contention resolution procedure may be omitted. When a plurality of candidate small cells (e.g., accessible small cells) exist, the terminal may access a specific small cell based on information on the plurality of candidate small cells, and perform an RA procedure by using a RACH resource of the specific small cell. By performing the RA procedure, the terminal may inform the small cell to which the terminal is actually accessing among the plurality of candidate small cells.

After the terminal completes access to the small cell, information (e.g., CSI report information) that the terminal needs to report to the small cell may exist. In this case, the small cell may inform the terminal of uplink resource information for reporting by the terminal. Based on the above-described procedure, after completing access to the small cell, the terminal may report the information (e.g., CSI report information) to the small cell using the uplink resource configured by the small cell without performing a separate resource allocation procedure.

The information set 2 may include information other than the information 2-A to information 2-I. The information set 2 may include some information among the information 2-A to information 2-I. The information set 2 may be information on one small cell to which the terminal can access (e.g., one adjacent small cell) or information on a plurality of candidate small cells (e.g., candidate small cells to which the terminal can access). The macro base station may request SSB transmission from the small cell based on the information set 2 (e.g., at least one information from the information 2-A to information 2-I). In this case, essential information that the macro base station needs to inform the small cell may be all or part of the information 2-A to information 2-I. The essential information that the macro base station needs to inform the small cell may include information other than the information 2-A to information 2-I. The small cell may perform actual SSB transmission based on the information (e.g., information set 2) received from the macro base station. Depending on the time resources (e.g., time period, transmission periodicity)/frequency resources available for SSB transmission, various types of SSB transmission may be possible.

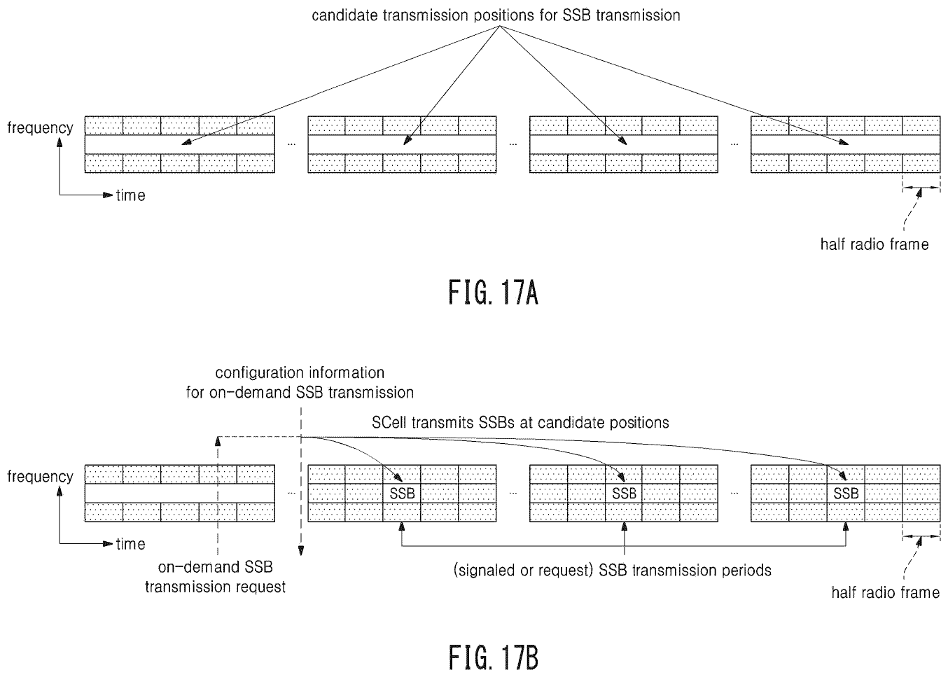

FIGS. 16A and 16B are conceptual diagrams illustrating SSB transmission of a small cell in a preconfigured time period(s) (e.g., transmission periodicity).

Referring to FIGS. 16A and 16B, time resources available for SSB transmission may be configured in advance. Therefore, configuring and/or transmitting the time resource information (e.g., time resource(s), time period(s), transmission periodicity) in the information 2-E may not be necessary. The small cell may transmit SSB(s) based on the information 2-F (e.g., number of SSB transmissions) configured by the macro base station. When the above-described method is used, there is no need to separately configure/transmit time resource information (e.g., time resource(s), time period(s), transmission periodicity) for SSB transmission, and accordingly, the signaling overhead of information for SSB transmission can be reduced, and the communication system (e.g., SSB transmission procedure) can be implemented simply. Instead of the number of SSB transmission periods (e.g., SSB transmission periodicity), a termination time (e.g., end time) of SSB transmissions associated with the start time of SSB transmissions of the information 2-D may be set, and information on the termination time of SSB transmissions may be signaled to the terminal. In this case, the SSB transmissions may be performed in a period from the start time to the termination time. Alternatively, if the number of SSB transmission periods and/or the termination time of SSB transmissions is not set/signaled, the started SSB transmissions may continue to be performed until the base station stops the SSB transmissions. Alternatively, the time resources (e.g., time period(s), transmission periodicity) may be allocated flexibly, and the SSB transmissions may be dynamically allocated based on the flexible time resources (e.g., time period(s), transmission periodicity).

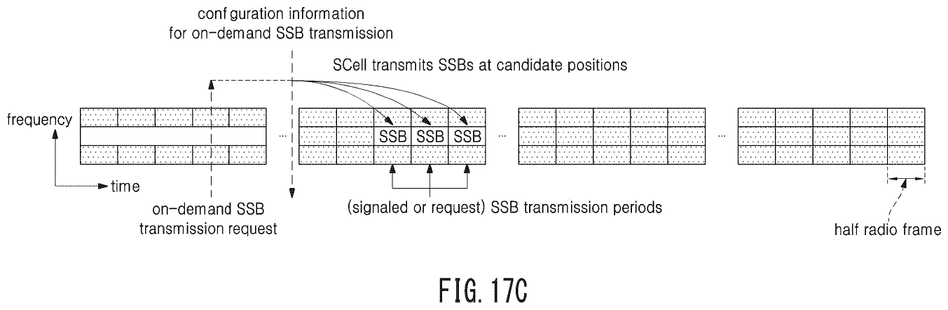

FIGS. 17A, 17B, and 17C are conceptual diagrams illustrating SSB transmissions of a small cell in flexible time period(s) (e.g., flexible transmission periodicity).

Referring to FIGS. 17A, 17B, and 17C, flexible time resource(s) (e.g., time period(s), transmission periodicity) for SSB transmission may be configured. In this case, additional signaling for the SSB transmission periodicity is required, but the SSB transmission periodicity may be set flexibly. The SSB transmission periodicity may be set differently depending on capability of each terminal. Therefore, a synchronization procedure (e.g., synchronization procedure for the small cells) can be performed quickly. If a hypothesis test is required for the synchronization procedure, a terminal with sufficient processing power can quickly complete the synchronization procedure based on a short SSB transmission periodicity as in the exemplary embodiment of FIG. 17C. A terminal with insufficient processing power may perform the synchronization procedure based on a long SSB transmission periodicity as in the exemplary embodiment of FIG. 17B to secure sufficient processing time for the hypothesis test.

The macro base station may set the SSB transmission periodicity (e.g., information 2-E) based on the information 1-B reported from the terminal. Alternatively, the macro base station may use the information 1-B reported from the terminal as the information 2-F. In this case as well, like SSB transmission based on the information 2-F, SSB transmission may be performed based on the number of SSB transmission periods and/or configuration and/or signaling for the termination time of SSB transmissions. After the SSB transmission periods and/or the termination time of SSB transmission, SSB transmissions may be stopped (e.g., terminated).

Alternatively, after the SSB transmission periods and/or the termination time of SSB transmission, SSB transmission may be performed based on another SSB transmission periodicity. In other words, after the SSB transmission periods and/or the termination time of SSB transmission, the SSB transmission periodicity may be changed, and SSB transmissions may be performed based on the changed SSB transmission periodicity. The another SSB transmission periodicity (e.g., changed SSB transmission periodicity) may be a default SSB transmission periodicity (e.g., 20 ms). The default SSB transmission periodicity may be used in initial access procedures. Alternatively, the another SSB transmission periodicity (e.g., changed SSB transmission periodicity) may be a separately set SSB transmission periodicity. It may be preferable for the another SSB transmission periodicity (e.g., changed SSB transmission periodicity) to be set to a larger value than the previous SSB transmission periodicity. If the number of separate SSB transmission periods and/or a termination time of SSB transmissions is not set and/or signaled, the started SSB transmission may continue to be performed until the base station stops the SSB transmission.

Although there is one frequency resource for SSB transmission in the exemplary embodiments of FIGS. 17A, 17B, and 17C, the exemplary embodiments of the present disclosure may also be applied when a plurality of frequency resources for SSB transmission exist. In this case, additional information may be needed to indicate the frequency resource(s) for SSB transmission.

3. After a Synchronization Procedure (e.g., Synchronization Procedure for the Small Cell) is Completed, the Terminal May Report Information on Whether the Synchronization Procedure has been Completed to the Macro Base Station and/or Small Cell.

The terminal may complete the synchronization procedure based on SSB(s) received from the small cell. After the synchronization procedure is completed, the terminal may report (e.g., transmit) information on the completed synchronization procedure to the macro base station and/or small cell. For example, the terminal may transmit an information set 3 below to the macro base station and/or small cell. The macro base station and/or small cell may receive the information set 3 from the terminal. The information set 3 may include at least one information among information 3-A, information 3-B, information 3-C, or information 3-D. The information set 3 may also include information other than the information 3-A or information 3-D.

### <Information Set 3>

Information 3-A: Synchronization complete message (e.g., success or failure)
Information 3-B: Optimal M beam(s) (e.g., optimal beam index(es), optimal transmission beam index(es)), M is a natural number
Information 3-C: Optimal reception beam (e.g., optimal reception beam index)
Information 3-D: link quality (ies) corresponding to the optimal beam index(es)

After the synchronization procedure is completed, the terminal may report information on whether synchronization is completed (e.g., information 3-A) to the base station (e.g., macro base station and/or small cell). The information 3-A may be information indicating whether the synchronization procedure is successful. When the information 3-B, information 3-C, and/or information 3-D is reported to the base station, the base station may determine that the synchronization procedure is completed based on the reported information. In this case, the terminal may omit transmission of the information 3-A. In the synchronization procedure, the terminal may find an optimal beam pair. The optimal beam pair may include an optimal transmission beam and an optimal reception beam.

When SSBs are transmitted in a beam sweeping scheme (e.g., when the SSBs are transmitted through different beams in the time domain), the terminal may measure a reception quality (e.g., RSRP, signal to noise (SNR), signal to interference plus noise ratio (SINR)) for each of the SSBs, and find the optimal beam pair based on the measured reception qualities (e.g., measured link qualities). The terminal may inform the base station of the optimal beam pair by reporting the information 3-B and/or information 3-C.

The information 3-B may be information on the optimal transmission beam(s) of the small cell. The information 3-B may be information on the optimal M transmission beams. M may be a natural number. The optimal M transmission beams may be M transmission beams with good quality among all transmission beams of the small cell. Indexes of the optimal M transmission beams may be included in the information 3-B in order of good quality.

The information 3-C may be information on the optimal reception beam(s) of the terminal. Since the information 3-C is information required by the terminal, the information 3-C may not be reported to the base station. The terminal may inform the base station of a link quality (e.g., RSRP, SNR, SINR) for the optimal beam pair by reporting the information 3-D.

All or some information included in the information set 3 may include a rank indicator (RI), a precoding matrix indicator (PMI), and/or a layer indicator (LI). The reporting procedure for the information set 3 may be the same or similar to a CSI reporting procedure. A method of transmitting the information set 3 (e.g., information belonging to the information set 3) may vary depending on a reported target and/or reporting scheme.

Transmission Method 1: The Terminal May Transmit the Information Set 3 to the Macro Base Station Through a PUCCH and/or PUSCH

The terminal may transmit the information set 3 to the macro base station through a PUCCH and/or PUSCH. The macro base station may receive the information set 3 from the terminal, and may deliver the information set 3 to the small cell through an interface between the macro base station and the small cell. The small cell may receive the information set 3 from the macro base station.

Transmission Method 2: The Terminal May Transmit the Information Set 3 to the Small Cell Through a RACH and/or SRS

The terminal may transmit the information set 3 to the small cell through a RACH and/or SRS. The RACH and/or SRS may be used to transmit some information belonging to the information set 3. The small cell may receive the information set 3 from the terminal and deliver the information set 3 to the macro base station through an interface between the small cell and the macro base station. The macro base station may receive the information set 3 from the small cell.

Transmission Method 3: The Terminal May Transmit the Information Set 3 to the Macro Base Station Through a PUCCH and/or PUSCH, and Transmit the Information Set 3 to the Small Cell Through a RACH and/or SRS

The terminal may transmit the information set 3 to the macro base station through a PUCCH and/or PUSCH, and may transmit the information set 3 to the small cell through a RACH and/or SRS. Each of the macro base station and small cell may receive the information set 3 from the terminal. Information transmitted to each of the macro base station and small cell may be some information belonging to the information set 3.

Transmission Method 4: The Terminal May Transmit the Information Set 3 to the Small Cell Through a PUCCH and/or PUSCH

The terminal may complete the synchronization procedure based on the SSB(s) received from the small cell. After the synchronization procedure is completed, the terminal may receive reporting configuration information from the macro base station and/or small cell. The terminal may transmit the information set 3 to the small cell through a PUCCH and/or PUSCH based on the reporting configuration information. The small cell may receive the information set 3 from the terminal. The reporting configuration information may include information necessary for transmission of the information set 3. For example, the reporting configuration information may include information on a resource for the PUCCH and/or PUSCH. The information transmitted to the small cell may be some information belonging to the information set 3.

The reporting procedure for the information set 3 may be the same or similar to a CSI reporting procedure. If the reporting procedure for the information set 3 is the same or similar to the CSI reporting procedure, it may be preferable for the transmission method 4 to be used.

4. Whether or not to Perform an SSB Retransmission Procedure May be Decided Depending on Whether the Synchronization Procedure is Completed. Modified SSB Transmission Configuration Information May be Configured as Needed.

If the synchronization procedure (e.g., the synchronization procedure between the terminal and the small cell) is not completed even after the SSB transmission configured by the macro base station is completed, the macro base station may decide whether to perform an SSB retransmission procedure. The macro base station may determine whether the synchronization procedure is completed based on a synchronization complete message reported from the terminal. The macro base station may determine whether the synchronization procedure is completed based on information (e.g., success or failure) indicated by the synchronization complete message. Alternatively, the macro base station may determine whether the synchronization procedure is completed based on whether or not the synchronization complete message is received. Alternatively, the macro base station may determine whether the synchronization procedure is completed based on whether a PUCCH, PUSCH, RACH, and/or SRS including the information set 3 is received. Alternatively, the macro base station may determine whether the synchronization procedure is completed based on transmission of the information set 3 through a PUCCH, PUSCH, RACH, and/or SRS.

SSB transmission of the small cell may be triggered. If the terminal leaves a coverage of the small cell, SSB transmission of the small cell may not be necessary. In the above-described situation, the small cell may stop SSB transmission. Until SSB transmission is stopped (e.g., terminated) due to occurrence of a specific situation, the small cell may continue to perform SSB transmission. If the synchronization procedure for the small cell is not completed, the terminal may transmit a synchronization failure message to the base station. If the synchronization failure message is received from the terminal, the base station may determine that the synchronization procedure is not completed. The synchronization failure message may be a synchronization complete message indicating a failure. The base station may determine whether the synchronization procedure is complete based on whether a PUCCH, PUSCH, RACH, and/or SRS including the information set 3 is received. For example, if reception of a PUCCH, PUSCH, RACH, and/or SRS including the information set 3 fails, the base station may determine that the synchronization procedure is not completed.

If the synchronization procedure is not completed and/or the synchronization failure message is received, the macro base station may indicate (e.g., request) the small cell to retransmit SSB(s). To indicate SSB retransmission, the macro base station may transmit an information set 4 below to the small cell. In addition, the macro base station may transmit the information set 4 below to the terminal. The information set 4 may include at least one of information 4-A or information 4-B. The information set 4 may include information other than the information 4-A and/or information 4-B. The information set 4 may be modified on-demand SSB transmission configuration information.

### <Information Set 4>

Information 4-A: SSB retransmission indication
Information 4-B: Reconfiguration information including the increased number of SSB transmissions, modified periods, modified periodicity, etc. The reconfiguration information may be used for modified transmission of synchronization signals.

The information 4-A may be information indicating SSB retransmission. The information 4-B may be SSB retransmission configuration information. The information 4-B may include at least one of the information 2-A, information 2-B, information 2-C, information 2-D, information 2-E, information 2-F, or information 2-G (e.g., at least one information that needs to be updated). For reliable and stable synchronization in the SSB retransmission procedure, it may be preferable to increase the number of SSB transmissions. The number of SSB transmissions may be indicated by the information 2-F.

The SSB transmission may continue to be performed without the need to determine whether to perform the SSB retransmission procedure. In other words, the SSB transmission may continue to be performed until the synchronization complete message is received or until the synchronization procedure is determined to be completed. If SSB transmission is configured and/or indicated by the macro base station, the small cell may continue to perform

SSB transmission until the synchronization procedure is determined to be completed. The SSB transmission of the small cell may be performed according to a preset SSB transmission periodicity. In the terminal's SSB transmission procedure, some of the SSB transmission configuration information (e.g., information 2-D and/or information 2-F) may not be necessary. When the synchronization complete message is received directly from the terminal or when the synchronization complete message of the terminal is received through the macro base station, the small cell may determine that the synchronization procedure of the terminal is completed. Alternatively, the small cell may determine that the synchronization procedure of the terminal is completed based on another method.

If a specific number or more of SSBs are transmitted according to the SSB transmission periodicity based on the SSB transmission configuration information, or if SSBs are transmitted during a specific time period based on the SSB transmission configuration information, the SSB transmission periodicity may be changed, and the SSB transmission may be continue to be performed based on the changed SSB transmission periodicity. The SSB transmission procedure may be performed without the need to determine whether to retransmit SSBs. The changed SSB transmission periodicity (e.g., another SSB transmission periodicity) may be a default SSB transmission periodicity (e.g., 20 ms). The default SSB transmission periodicity may be used in initial access procedures. Alternatively, another SSB transmission periodicity (e.g., changed SSB transmission periodicity) may be a separately set SSB transmission periodicity. It may be preferable for the another SSB transmission periodicity (e.g., changed SSB transmission periodicity) to be set to a larger value than the previous SSB transmission periodicity. On-demand SSB transmission configuration information may include one or more SSB transmission periodicities, and the another SSB transmission periodicity may be one SSB transmission periodicity among the one or more SSB transmission periodicities.

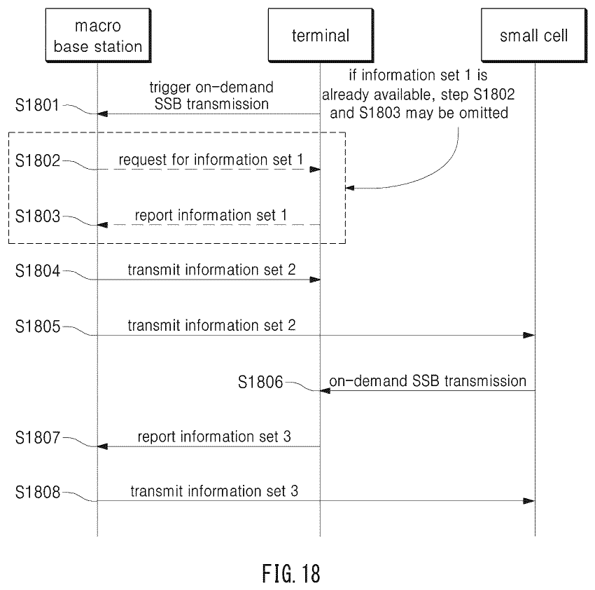

FIG. 18 is a sequence chart illustrating exemplary embodiments of a method for transmitting on-demand SSB.

Referring to FIG. 18, a macro base station may refer to a first base station, and a small cell may refer to a second base station. Alternatively, the macro base station may refer to a first cell, and the small cell may refer to a second cell. The small cell may transmit SSB(s) based on a request of the terminal and/or macro base station. The terminal may transmit a signal triggering on-demand SSB transmission to the macro base station (S1801). The macro base station may confirm that on-demand SSB transmission is triggered based on the signal received from the terminal. Alternatively, on-demand SSB transmission may be triggered by the macro base station. In this case, step S1801 may be omitted. When SSB transmission of the small cell is required (e.g., when on-demand SSB transmission is triggered), the macro base station may transmit a signal requesting provision of the information set 1 to the terminal (S1802). The terminal may confirm that provision of the information set 1 is requested based on the signal received from the macro base station. The terminal may generate the information set 1 and transmit (e.g., report) the information set 1 to the macro base station (S1803). The macro base station may receive the information set 1 from the terminal and identify the information included in the information set 1.

In an initial access procedure between the terminal and the macro base station, the terminal may report the information set 1 to the macro base station. In the above-described situation, when the need for SSB transmission is raised by the macro base station, when the need for SSB transmission is raised by the terminal, or when a signal triggering on-demand SSB transmission is received from the terminal, steps S1802 and S1803 may be omitted.

The macro base station may generate the information set 2 based on the information set 1 received from the terminal. The macro base station may transmit the information set 2 to the terminal (S1804). The terminal may receive the information set 2 from the macro base station and identify the information included in the information set 2. The macro base station may transmit the information set 2 to the small cell (S1805). The small cell may receive the information set 2 from the macro base station and identify the information included in the information set 2.

The small cell may confirm that SSB transmission is required based on the information set 2. In other words, the small cell may confirm that on-demand SSB transmission is triggered based on the information set 2. The small cell may transmit SSB(s) to the terminal based on the information set 2 (S1806). The terminal may receive SSB(s) from the small cell and perform a synchronization procedure based on the SSB(s). The terminal may generate the information set 3 including a result of the synchronization procedure. The terminal may transmit the information set 3 to the macro base station (S1807).

The macro base station may receive the information set 3 from the terminal. The macro base station may confirm whether the synchronization procedure is successful based on the information included in the information set 3. The macro base station may decide whether to perform an SSB retransmission procedure based on the information included in the information set 3. The macro base station may deliver the information set 3 of the terminal to the small cell (S1808). The small cell may receive the information set 3 from the macro base station. The small cell may confirm whether the synchronization procedure is successful based on the information included in the information set 3. The small cell may decide whether to perform an SSB retransmission procedure based on the information included in the information set 3. In the exemplary embodiment of FIG. 18, the information set 3 may be reported and/or transmitted based on the transmission method 1. The information set 3 may be reported and/or transmitted based on the transmission method 2, transmission method 3, or transmission method 4 instead of the transmission method 1.

If it is determined that SSB transmission by the small cell is required without the information set 1, the macro base station may deliver the information set 2 to the small cell. The information set 2 may be configured in advance by the macro base station. The small cell may receive the information set 2 from the macro base station and perform SSB transmission based on the information included in the information set 2. As another method, if it is determined that SSB transmission by the small cell is required, the macro base station may transmit a signaling message triggering SSB transmission to the small cell without delivering the information set 2. The small cell may receive the signaling message from the macro base station, confirm that SSB transmission is triggered based on the signaling message, and perform SSB transmission. The SSB transmission may be performed based on the information set 2 (e.g., information corresponding to the information set 2). The information set 2 (e.g., information corresponding to the information set 2) may be configured in advance in the small cell.

The information set transmitted in each step of the exemplary embodiment of FIG. 18 may include a portion of or the entire information set proposed in the present disclosure. On-demand SSB transmission may be performed not only by the small cell but also by another base station and/or cell depending on a configuration by the macro base station. The exemplary embodiment of FIG. 18 (e.g., on-demand SSB transmission procedure) may be applied to all types of base stations constituting primary cells and secondary cells. The macro cell may be a primary cell (PCell) or a primary secondary cell (PSCell). The small cell may be a secondary cell (SCell). The SSB may be an SSB including a PSS, SSS, and PBCH. The SSB may be an SSB including a PSS and SSS without a PBCH. The SSB may be an SSB that includes only an SSS. The SSB may include a PSS with a sequence (e.g., new sequence) that is different from the existing sequence. The SSB may include an SSS with a sequence (e.g., new sequence) that is different from the existing sequence.

As a method different from step S1801, the terminal may directly transmit a signaling message for triggering SSB transmission to the small cell. The signaling message (e.g., signal) for triggering SSB transmission may be transmitted through an uplink signal and/or channel (e.g., RACH, SRS, PUCCH, PUSCH). Information on the uplink signal and/or channel for transmission of the signaling message for triggering SSB transmission may be configured (e.g., indicated) through signaling of the macro base station (e.g., UE-specific RRC, MAC CE, DCI (e.g., common DCI)).

The small cell may receive the signaling message from the terminal, confirm that SSB transmission is triggered based on the signaling message, and perform SSB transmission. The small cell may start SSB transmission based on all or part of information belonging to the information set 2 (e.g., preconfigured information set 2). The small cell may start SSB transmission at the earliest SSB transmission time among candidate SSB transmission times after a processing time for the signaling message for triggering SSB transmission. A time of transmitting the uplink signal and/or channel for triggering SSB transmission may be inferred based on a downlink synchronization signal. Since the time of transmitting the uplink signal and/or channel for triggering SSB transmission is a time before the SSB transmission of the small cell starts, it may be inferred based on an SSB transmitted from the macro base station.

Alternatively, uplink transmission configuration information received from the macro base station may include information related to the time of transmitting the uplink signal and/or channel for the small cell. The terminal may identify (e.g., infer) the time of transmitting the uplink signal and/or channel for the small cell based on the uplink transmission configuration information (e.g., information for transmission of the uplink signal and/or channel) received from the macro base station, and transmit the uplink signal and/or channel for triggering SSB transmission to the small cell at that transmission time.

In an environment where a primary cell and secondary cell(s) are configured, a secondary cell performing non stand-alone (NSA) operations may support on-demand SSB transmission functions. In addition, a cell performing stand-alone (SA) operations may also support on-demand SSB transmission functions. Since a base station performing SA operations is not able to receive SSB transmission configuration information from another base station in advance, the SSB transmission configuration information may be preconfigured. If there is no terminal within a coverage of a base station or if there is no terminal requiring SSB reception, the base station may not perform SSB transmission to reduce energy consumption. When a new terminal enters the coverage of the base station, or when a terminal within the coverage of the base station needs to receive SSB for initial access, the terminal may request SSB transmission from the base station, and the base station may transmit SSB(s) according to the terminal's request. In this case, the terminal may transmit a cell-wakeup signal (C-WUS) to the base station to request SSB transmission.

In an activated SCell, the terminal may initiate a beam failure recovery procedure due to a beam failure. In this case, since the terminal is able to make more appropriate decisions than the base station, the terminal may request an appropriate SSB beam from the base station or report an inappropriate SSB beam to the base station. The SSB beam may be a beam used for SSB transmission. In this scenario, a latency of the beam failure recovery procedure based on on-demand SSB may be less than a latency of the beam failure recovery procedure based on periodic SSB. If the configured SCell is not activated, overload may occur due to uplink (UL) traffic (e.g., MAC CE for reporting a buffer status) that is unknown to the base station. Activation of the SCell may be required to offload UL traffic. In other words, the terminal may request activation of the SCell to offload UL traffic.

The terminal may trigger on-demand SSB transmission to activate the SCell. For fast activation of the SCell, the procedure for triggering on-demand SSB transmission may be more efficient than a procedure in which the terminal reports an uplink buffer status to the base station and the base station triggers SCell activation based on the terminal's uplink buffer status. In other words, if the terminal does not receive a signal (e.g., data) from a base station of the activated SCell for a long time, the terminal may lose synchronization with the base station. In the above-described situation, the terminal may need to receive multiple SSB burst sets for resynchronization. For fast resynchronization with the SCell, using on-demand SSBs may be more efficient than using existing SSBs with a long periodicity. In this case, to trigger on-demand SSB transmission, the terminal may transmit a C-WUS.

At a time the terminal transmits a C-WUS to the base station, the terminal may not be synchronized with the base station. In this case, since the base station cannot predict the time at which the terminal transmits a C-WUS, continuous monitoring of the terminal's C-WUS may be necessary. The energy consumption of the base station may increase due to the C-WUS monitoring operation. Considering resource efficiency, a C-WUS may be transmitted according to a preset periodicity. In other words, C-WUS transmission may not always be possible. A synchronization procedure between the terminal and the base station may be necessary before transmitting a C-WUS so that the base station can predict a time at which the terminal transmits the C-WUS. It may be preferable for the base station to transmit a separate SSB (e.g., simplified(S)-SSB) for the synchronization procedure between the terminal and the base station instead of the existing SSB (e.g., normal (N)-SSB).

A base station that supports transmission and reception operations using multiple beams may derive a reception beam based on a transmission beam. A terminal that supports transmission and reception operations using multiple beams may derive a transmission beam based on a reception beam. The base station may transmit S-SSB(s) using a beam sweeping scheme. The terminal may receive S-SSB(s) from the base station and derive a transmission beam for C-WUS transmission based on the S-SSB(s). A candidate transmission time of a C-WUS may be set according to a specific offset based on the S-SSB. Alternatively, a candidate transmission time of a C-WUS may be set as the earliest time after a specific time in consideration of a processing time of the received S-SSB.

The base station may transmit S-SSB(s) for the synchronization procedure instead of N-SSB. For example, the S-SSB may consist of only a PSS or SSS of the N-SSB. Alternatively, the S-SSB may be configured with a new type of sequence. It may be preferable in terms of energy saving to set a transmission periodicity of the S-SSB to be longer than a transmission periodicity of the N-SSB (e.g., 20 ms). It may be preferable to configure a transmission resource of the S-SSB so as not to overlap with a transmission resource of the N-SSB. The terminal may perform the synchronization procedure (e.g., downlink synchronization procedure) with the base station based on the S-SSB, and may derive a transmission beam suitable for C-WUS transmission based on the S-SSB. After deriving the transmission beam, the terminal may predict a candidate transmission time of C-WUS based on the synchronization between the terminal and the base station, and transmit a C-WUS to the base station using the transmission beam derived at the predicted candidate transmission time.

The candidate transmission time of C-WUS may vary depending on additionally received S-SSB(s). If reception of an S-SSB is successful, the terminal may transmit a C-WUS at a time associated with the S-SSB. To support the above-described operation, an association between a candidate transmission time C-WUS and the S-SSB may be established in advance. Although the uplink synchronization procedure between the base station and the terminal has not been performed, the base station may predict a transmission time of the terminal's C-WUS in accordance with the downlink synchronization. Therefore, the base station may perform a C-WUS monitoring operation at the predicted transmission time. In this case, energy consumption can be reduced compared to continuous C-WUS monitoring operations.

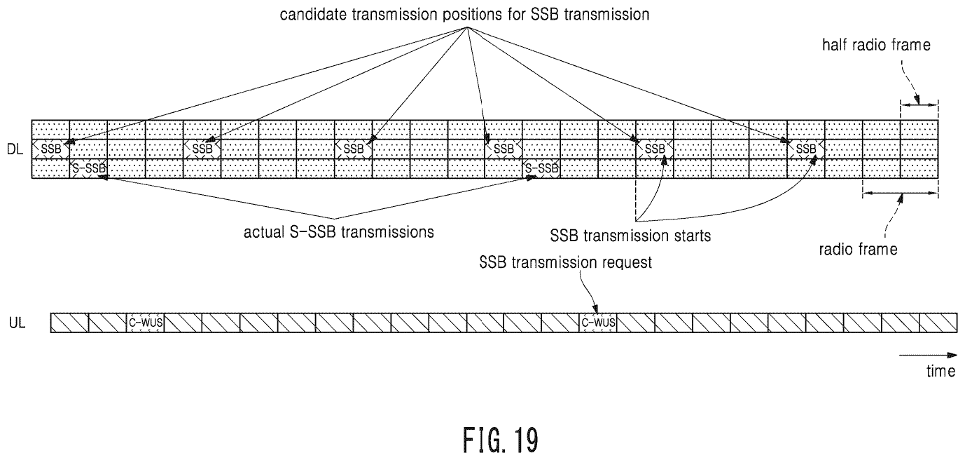

FIG. 19 is a conceptual diagram illustrating exemplary embodiments of S-SSB transmission and C-WUS transmission.

Referring to FIG. 19, a base station may transmit S-SSB(s). A transmission periodicity of the S-SSB may be longer than that of the N-SSB (e.g., SSB). The SSB shown in FIG. 19 may mean the N-SSB. The terminal may receive S-SSB(s) from the base station and determine a C-WUS transmission time (e.g., candidate transmission time) based on the S-SSB. The terminal may transmit a C-WUS to the base station at the determined transmission time. The base station may receive the C-WUS from the terminal and transmit N-SSB(s) to the terminal. The terminal may receive the N-SSB from the base station. The C-WUS may trigger transmission of the N-SSB. The transmission of the N-SSB may be on-demand SSB transmission.

The N-SSB transmission periodicity may be set to 20 ms. The transmission periodicity of S-SSB to obtain synchronization required for C-WUS transmission may be set to 60 ms. The terminal may acquire synchronization based on the S-SSB and request N-SSB transmission by transmitting a C-WUS based on the synchronization. After the C-WUS is received from the terminal, the base station may transmit N-SSB(s). In other words, when the C-WUS is received from the terminal, the base station may determine that N-SSB transmission is requested and transmit N-SSB(s) based on the determination.

The S-SSB transmission periodicity may be longer than the N-SSB transmission periodicity, and a structure of the S-SSB may be simpler than that of the N-SSB. In this case, signaling overhead and/or energy consumption for S-SSB transmission can be reduced. The exemplary embodiment of FIG. 19 may be applied to both FDD systems and TDD systems regardless of a duplex mode.

When the C-WUS is received from the terminal, the base station may transmit N-SSB(s) having the same structure as the existing SSB. The terminal may receive the N-SSB from the base station and perform an initial access procedure based on the N-SSB. When a PRACH (e.g., Msg1) is received from the terminal performing the initial access procedure based on the N-SSB, the base station may stop N-SSB transmission. When the CBRA scheme is used, a possibility that terminals transmit the same PRACH may be high. Therefore, after a Msg3 is received from the terminal, the base station may stop N-SSB transmission. As another method, after feedback information (e.g., ACK or NACK) for a Msg4 is received from the terminal, the base station may stop N-SSB transmission.

If a specific signal and/or channel (e.g., feedback information for PRACH, Msg3, Msg4) is received from the terminal after the base station transmits the N-SSB at the request of the terminal, the base station may stop transmitting the N-SSB. If the specific signal and/or channel is not received from the terminal, the base station may continue to perform N-SSB transmission. In this case, the effect of reducing energy consumption may be minimal.

If the base station does not receive the specific signal and/or channel from the terminal after a specific time or period from a time of transmitting the on-demand SSB (e.g., N-SSB), the base station may stop transmitting the on-demand SSB. The specific time and/or specific period may be preconfigured. Considering the beam sweeping operation, an SSB burst may be composed of a plurality of adjacent N-SSBs. Since an SSB burst is transmitted during one period, the number of transmissions of SSB bursts (e.g., the number of SSB bursts) may be set instead of the specific time and/or specific period.

The exemplary embodiments of the present disclosure may be applied to SSB transmission upon request from the terminal. The exemplary embodiments of the present disclosure may also be applied to transmission of system information (e.g., SIB1) that has a one-to-one mapping relationship with SSB. In other words, the SSB and SIB1 mapped to the SSB may be transmitted based on the terminal's request. If transmission of the SSB is stopped, transmission of the SIB1 mapped to the SSB may also be stopped.

The C-WUS may be an existing uplink signal and/or channel (e.g., PUCCH, PUSCH, SRS, RACH). The C-WUS may be a new signal and/or channel, and the new signal and/or channel may be composed of a new sequence. The RA procedure may support the CBRA scheme and/or the CFRA scheme. Therefore, the C-WUS may be transmitted based on the CBRA scheme or CFRA scheme. The C-WUS may be transmitted through a PUCCH and/or PUSCH. In this case, SSB transmission request information for a plurality of SCells may be configured as a bitmap, and the bitmap may be included in the C-WUS.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving on-demand synchronization signal block (SSB) transmission configuration information from a first base station to which the terminal is connected; and
receiving an on-demand SSB from a second base station based on the on-demand SSB transmission configuration information,
wherein the on-demand SSB transmission configuration information includes at least one of capability information of the second base station, on-demand SSB resource information, a number of on-demand SSB transmissions, on-demand SSB transmission indication, or channel state information (CSI) configuration information.

2. The method according to claim 1, wherein the capability information includes at least one of a cell identifier (ID), system bandwidth, numerology, number of beams, or antenna configuration of the second base station.

3. The method according to claim 1, wherein the on-demand SSB resource information includes at least one of time resource information for on-demand SSB transmission, frequency resource information for on-demand SSB transmission, periodicity information for on-demand SSB transmission, information on a time at which actual transmission of the on-demand SSB is started, or information a time at which the actual transmission of the on-demand SSB is terminated.

4. The method according to claim 3, wherein the time resource information includes at least one of a system frame number (SFN), a half radio frame indicator, a subframe index, a slot index, or information on actually transmitted SSB(s).

5. The method according to claim 3, wherein the frequency resource information includes at least one of information on a synchronization raster or information on an absolute radio frequency channel number (ARFCN).

6. The method according to claim 1, wherein the on-demand SSB transmission indication is information indicating activation of the second base station.

7. The method according to claim 1, wherein the CSI configuration information includes information on a resource for reporting CSI generated based on a measurement result of the on-demand SSB.

8. The method according to claim 1, wherein the on-demand SSB is a cell defining SSB or non-cell defining SSB.

9. The method according to claim 1, wherein the on-demand SSB is received at a frequency position other than a synchronization raster.

10. The method according to claim 1, wherein when the on-demand SSB is a cell-defining SSB, the on-demand SSB includes a first barring indicator, and the first barring indicator is used to block a legacy terminal from accessing the second base station.

11. The method according to claim 10, wherein when the terminal is a terminal capable of receiving the on-demand SSB, the terminal ignores the first barring indicator included in the on-demand SSB, and the terminal decides whether the terminal is barred from the second base station based on a second barring indicator included in remaining minimum system information (RMSI) received from the second base station.

12. A method of a first base station, comprising:
generating on-demand synchronization signal block (SSB) transmission configuration information including at least one of capability information of a second base station, on-demand SSB resource information, a number of on-demand SSB transmissions, on-demand SSB transmission indication, or channel state information (CSI) configuration information; and
transmitting the on-demand SSB transmission configuration information a terminal,
wherein an on-demand SSB based on the on-demand SSB transmission configuration information is transmitted from the second base station to the terminal.

13. The method according to claim 12, wherein the capability information includes at least one of a cell identifier (ID), system bandwidth, numerology, number of beams, or antenna configuration of the second base station.

14. The method according to claim 12, wherein the on-demand SSB resource information includes at least one of time resource information for on-demand SSB transmission, frequency resource information for on-demand SSB transmission, periodicity information for on-demand SSB transmission, information on a time at which actual transmission of the on-demand SSB is started, or information a time at which the actual transmission of the on-demand SSB is terminated.

15. The method according to claim 12, wherein when the on-demand SSB is a cell-defining SSB, the on-demand SSB includes a first barring indicator, and the first barring indicator is used to block a legacy terminal from accessing the second base station.

16. The method according to claim 12, further comprising:
when a synchronization procedure between the terminal and the second base station is not completed, generating modified on-demand SSB transmission configuration information;
transmitting the modified on-demand SSB transmission configuration information to the second base station; and
transmitting the modified on-demand SSB transmission configuration information to the terminal,
wherein the on-demand SSB is retransmitted from the second base station to the terminal based on the modified on-demand SSB transmission configuration information.

17. A method of a second base station, comprising:
receiving on-demand synchronization signal block (SSB) transmission configuration information from a first base station; and
transmitting an on-demand SSB to a terminal based on the on-demand SSB transmission configuration information,
wherein the on-demand SSB transmission configuration information includes at least one of capability information of the second base station, on-demand SSB resource information, a number of on-demand SSB transmissions, on-demand SSB transmission indication, or channel state information (CSI) configuration information.

18. The method according to claim 17, wherein the capability information includes at least one of a cell identifier (ID), system bandwidth, numerology, number of beams, or antenna configuration of the second base station.

19. The method according to claim 17, wherein the on-demand SSB resource information includes at least one of time resource information for on-demand SSB transmission, frequency resource information for on-demand SSB transmission, periodicity information for on-demand SSB transmission, information on a time at which actual transmission of the on-demand SSB is started, or information a time at which the actual transmission of the on-demand SSB is terminated.

20. The method according to claim 17, further comprising:
when a synchronization procedure between the terminal and the second base station is not completed, receiving modified on-demand SSB transmission configuration information from the first base station; and
retransmitting the on-demand SSB to the terminal based on the modified on-demand SSB transmission configuration information.
